(19) United States
(12) Patent Application Publication
(10) Pub. No.: US 2024/0364456 A1
(43) Pub. Date: Oct. 31, 2024

(54) INTERLEAVING METHOD, DEINTERLEAVING METHOD AND DEVICE

(71) Applicant: GUANGDONG OPPO MOBILE TELECOMMUNICATIONS CORP., LTD., Dongguan (CN)

(72) Inventors: Yapu LI, Dongguan (CN); Lei HUANG, Singapore (SG)

(21) Appl. No.: 18/761,261

(22) Filed: Jul. 1, 2024

Related U.S. Application Data
(63) Continuation of application No. PCT/CN2022/070389, filed on Jan. 5, 2022.

(51) Int. Cl. H04L 1/00; H04L 5/00

(52) U.S. Cl. CPC H04L 1/0071; H04L 5/0007; H04L 5/0046; H04L 5/0048

(57) ABSTRACT

An interleaving method includes: interleaving, by a first device, an RU according to first information, where the first information includes at least one of a bandwidth, an interleaving granularity or RU allocation information.

### CROSS-REFERENCE TO RELATED APPLICATION

This application is a continuation of International Application No. PCT/CN2022/070389 filed on Jan. 5, 2022, which is incorporated herein by reference in its entirety.

### TECHNICAL FIELD

The present disclosure relates to the field of communication, and more particularly, to an interleaving method, a deinterleaving method and a device.

### BACKGROUND

In a case of a transmission of a large-bandwidth orthogonal frequency division multiple access (OFDMA) extremely high throughput (EHT) physical layer protocol data unit (PPDU) involving a plurality of stations (STA), a resource unit (RU) or multiple resource units (MRUs) allocated to 1 STA can only enjoy a limited frequency diversity gain and cannot benefit from a large bandwidth.

### SUMMARY

Embodiments of the present disclosure provide an interleaving method, a deinterleaving method and a device.

The embodiments of the present disclosure provide an interleaving method, including: interleaving, by a first device, a resource unit (RU) according to first information, where the first information includes at least one of a bandwidth, an interleaving granularity or RU allocation information.

The embodiments of the present disclosure provide a deinterleaving method, including: receiving, by a second device, an OFDMA EHT PPDU; and deinterleaving, by the second device, an interleaved resource unit (RU) according to first information carried in the OFDMA EHT PPDU, where the first information includes at least one of a bandwidth, an interleaving granularity or RU allocation information.

The embodiments of the present disclosure provide a communication device, including: an interleaving module, configured to interleave a resource unit (RU) according to first information, where the first information includes at least one of a bandwidth, an interleaving granularity or RU allocation information.

The embodiments of the present disclosure provide a communication device, including: a receiving module, configured to receive an OFDMA EHT PPDU; and a deinterleaving module, configured to deinterleave an interleaved resource unit (RU) according to first information carried in the OFDMA EHT PPDU, where the first information includes at least one of a bandwidth, an interleaving granularity or RU allocation information.

The embodiments of the present disclosure provide a communication device, including a processer and a memory. The memory is configured to store a computer program, and the processor is configured to invoke and execute the computer program stored in the memory, to cause the terminal device to perform the above interleaving method or deinterleaving method.

The embodiments of the present disclosure provide a chip for implementing the above interleaving method or deinterleaving method.

In some embodiments, the chip includes a processor, configured to invoke and execute a computer program from a memory, to cause a device equipped with the chip to perform the above interleaving method or deinterleaving method.

The embodiments of the present disclosure provide a non-transitory computer-readable storage medium configured to store a computer program, where the computer program, when being executed on a device, causes the device to perform the above interleaving method or deinterleaving method.

The embodiments of the present disclosure provide a computer program product including computer program instructions, where the computer program instructions cause a computer to perform the above interleaving method or deinterleaving method.

The embodiments of the present disclosure provide a computer program, where the computer program, when being executed on a computer, causes the computer to perform the above interleaving method or deinterleaving method.

### BRIEF DESCRIPTION OF THE DRAWINGS

FIG. 1 is a schematic diagram of an application scenario according to the embodiments of the present disclosure.

FIG. 2 is a schematic flowchart of an interleaving method 200 according to an embodiment of the present disclosure.

FIG. 3 is a schematic diagram of an EHT MU PPDU format according to an embodiment of the present disclosure.

FIG. 4 is a schematic diagram of a transmission process in an interleaving method according to an embodiment of the present disclosure.

FIG. 5 is a schematic diagram of RU interleaving according to an embodiment of the present disclosure.

FIG. 6 is a schematic flowchart of a deinterleaving method 600 according to an embodiment of the present disclosure.

FIG. 7 is a schematic block diagram of a communication device 700 according to an embodiment of the present disclosure.

FIG. 8 is a schematic block diagram of a communication device 800 according to another embodiment of the present disclosure.

FIG. 9 is a schematic block diagram of a communication device 900 according to another embodiment of the present disclosure.

FIG. 10 is a schematic block diagram of a communication device 1000 according to another embodiment of the present disclosure.

FIG. 11 is a schematic block diagram of a communication device 1100 according to embodiments of the present disclosure.

FIG. 12 is a schematic block diagram of a chip 1200 according to the embodiments of the present disclosure.

FIG. 13 is a schematic block diagram of a communication system 1300 according to embodiments of the present disclosure.

### DETAILED DESCRIPTION

Technical solutions in the embodiments of the present disclosure will be described below with reference to the accompanying drawings in the embodiments of the present disclosure.

It needs to be noted that, terms “first”, “second”, etc., in the description and claims and the above drawings of the embodiments of the present disclosure are used to distinguish similar objects, and are not necessarily used to describe a specific order or sequence. At the same time, objects described by the described “first” and “second” may be the same or different from each other.

In the embodiments, an interleaving method is provided, which includes:
interleaving, by a first device, a resource unit (RU) according to first information, where the first information includes at least one of a bandwidth, an interleaving granularity or RU allocation information.

In some embodiments, in a case where the interleaving granularity is 26 tones, interleaving, by the first device, the RU according to the first information, includes:
dividing, by the first device, the bandwidth into a plurality of first physical RUs according to the interleaving granularity, where a size of the first physical RU is the same as a size of the interleaving granularity;
interleaving the plurality of first physical RUs according to a rule of an interleaver;
mapping interleaved plurality of first physical RUs to corresponding first virtual RUs respectively, where a plurality of the first virtual RUs form at least one of a second virtual RU, a first virtual multiple resource unit (MRU), a first logical RU or a first logical MRU, in sequence.

In some embodiments, dividing, by the first device, the bandwidth into the plurality of first physical RUs according to the interleaving granularity, includes:
in a case where the bandwidth is 80 MHz, dividing, by the first device, the bandwidth into 36 first physical RUs; or,
in a case where the bandwidth is 160 MHz, dividing, by the first device, the bandwidth into 72 first physical RUs; or,
in a case where the bandwidth is 320 MHz, dividing, by the first device, the bandwidth into 144 first physical RUs.

In some embodiments, in a case where the interleaving granularity is 52 tones, interleaving, by the first device, the RU according to the first information includes:
dividing, by the first device, the bandwidth into a plurality of first physical RUs and at least one second physical RU according to the interleaving granularity, where a size of the first physical RU is the same as a size of the interleaving granularity, and a size of the second physical RU is 26 tones;
interleaving the plurality of first physical RUs according to a rule of an interleaver; and
mapping interleaved plurality of first physical RUs to corresponding first virtual RUs respectively, and mapping a plurality of second physical RUs to corresponding third virtual RUs respectively, where a plurality of the first virtual RUs and the third virtual RUs form at least one of a fourth virtual RU, a second virtual MRU, a second logical RU or a second logical MRU, in sequence.

In some embodiments, dividing, by the first device, the bandwidth into the plurality of first physical RUs and the at least one second physical RU according to the interleaving granularity, includes:
in a case where the bandwidth is 80 MHz, dividing, by the first device, the bandwidth into 16 first physical RUs and 4 second physical RUs; or,
in a case where the bandwidth is 160 MHz, dividing, by the first device, the bandwidth into 32 first physical RUs and 8 second physical RUs; or,
in a case where the bandwidth is 320 MHz, dividing, by the first device, the bandwidth into 64 first physical RUs and 16 second physical RUs;

In some embodiments, the interleaver includes at least one of a block interleaver, a triangular interleaver, a spiral interleaver or a ladder interleaver.

In some embodiments, interleaving, by the first device, the RU according to the first information, occurs in a case where a first rule is satisfied; the first rule includes at least one of:
the interleaving granularity being 26 tones or 52 tones;
the bandwidth being greater than or equal to a preset bandwidth threshold;
at least one of a virtual RU, a virtual MRU, a logical RU or a logical MRU allocated to a single STA being a large-size RU/MRU;
a size of at least one of a virtual RU, a virtual MRU, a logical RU or a logical MRU allocated to a single STA being greater than or equal to M reference RUs, where the M is a positive integer, and the reference RU is a minimum interleaving unit;
a size of at least one of a virtual RU, a virtual MRU, a logical RU or a logical MRU allocated to a single STA being less than or equal to 1/N of a size of a bandwidth RU corresponding to the bandwidth, where the N is a positive integer;
a reduction rate of a number of data virtual tones or data logical tones included in at least one of a virtual RU, a virtual MRU, a logical RU or a logical MRU to a number of data tones included in a physical RU/MRU with a same size as the at least one of the virtual RU, the virtual MRU, the logical RU or the logical MRU, being less than or equal to a preset value; or
performing OFDMA transmission;
where the at least one of the virtual RU, the virtual MRU, the logical RU or the logical MRU allocated to the single STA is indicated by the RU allocation information.

In some embodiments, the preset bandwidth threshold is 40 MHz; and/or,
the large-size RU is an RU including 242 tones, 484 tones, 996 tones or 2×996 tones; and/or
the large-size MRU includes at least two large-size RUs; and/or
the M is 2 or 3; and/or
the N is 4; and/or
the preset value is 10%.

In some embodiments, a number of data virtual tones or data logical tones included in the at least one of the second virtual RU, the first virtual MRU, the first logical RU or the first logical MRU is different from a number of data tones included in a physical RU/MRU with a same size as the at least one of the second virtual RU, the first virtual MRU, the first logical RU or the first logical MRU; and/or
a number of pilot virtual tones or pilot logical tones included in the at least one of the second virtual RU, the first virtual MRU, the first logical RU or the first logical MRU is different from a number of pilot tones included in a physical RU/MRU with a same size as the at least one of the second virtual RU, the first virtual MRU, the first logical RU or the first logical MRU.

In some embodiments, positions of pilot physical tones of the at least one of the second virtual RU, the first virtual MRU, the first logical RU or the first logical MRU are the same as positions of pilot physical tones of the plurality of first physical RUs; and/or
positions of pilot physical tones of the at least one of the second virtual RU, the first virtual MRU, the first logical RU or the first logical MRU are the same as positions of pilot physical tones of the plurality of first physical RUs and at least one second physical RU.

In some embodiments, the method further includes:
determining, by the first device, a number of first data tones and/or a number of first pilot tones according to the first information;
where the number of first data tones is equal to the number of the data virtual tones or the data logical tones included in the at least one of the second virtual RU, the first virtual MRU, the first logical RU or the first logical MRU; or
the number of first pilot tones is equal to the number of the pilot virtual tones or the pilot logical tones included in the at least one of the second virtual RU, the first virtual MRU, the first logical RU or the first logical MRU.

In some embodiments, a number of data virtual tones or data logical tones included in the at least one of the fourth virtual RU, the second virtual MRU, the second logical RU or the second logical MRU is different from a number of data tones included in a physical RU/MRU with a same size as the at least one of the fourth virtual RU, the second virtual MRU, the second logical RU or the second logical MRU; and/or
a number of pilot virtual tones or pilot logical tones included in the at least one of the fourth virtual RU, the second virtual MRU, the second logical RU or the second logical MRU is different from a number of pilot tones included in a physical RU/MRU with a same size as the at least one of the fourth virtual RU, the second virtual MRU, the second logical RU or the second logical MRU.

In some embodiments, positions of pilot physical tones of the at least one of the fourth virtual RU, the second virtual MRU, the second logical RU or the second logical MRU are the same as positions of pilot physical tones of the plurality of first physical RUs; and/or
positions of pilot physical tones of the at least one of the fourth virtual RU, the second virtual MRU, the second logical RU or the second logical MRU are the same as positions of pilot physical tones of the plurality of first physical RUs and the at least one second physical RU.

In some embodiments, the method further includes:
determining, by the first device, a number of first data tones and/or a number of first pilot tones according to the first information;
where the number of first data tones is equal to the number of data virtual tones or data logical tones included in the at least one of the fourth virtual RU, the second virtual MRU, the second logical RU or the second logical MRU; or
the number of first pilot tones is equal to the number of pilot virtual tones or pilot logical tones included in the at least one of the fourth virtual RU, the second virtual MRU, the second logical RU or the second logical MRU.

In some embodiments, in a case where a size of at least one of a virtual RU, a virtual MRU, a logical RU or a logical MRU allocated to a single STA is 242 tones, the number of first data tones is 224, and the number of first pilot tones is 18; and/or
in a case where a size of at least one of a virtual RU, a virtual MRU, a logical RU or a logical MRU allocated to a single STA is 484 tones, the number of first data tones is 448, and the number of first pilot tones is 36; and/or
in a case where a size of at least one of a virtual RU, a virtual MRU, a logical RU or a logical MRU allocated to a single STA is 996 tones, the number of first data tones is 924, and the number of first pilot tones is 72; and/or,
in a case where sizes of RUs of at least one of a virtual RU, a virtual MRU, a logical RU or a logical MRU allocated to a single STA are 484 tones and 242 tones respectively, the number of first data tones is 672, and the number of first pilot tones is 54;
where the at least one of the virtual RU, the virtual MRU, the logical RU or the logical MRU allocated to the single STA is indicated by the RU allocation information.

In some embodiments, the method further includes:
determining, by the first device, according to the number of first data tones, at least one of a parameter used when an extremely high throughput (EHT) physical layer protocol data unit (PPDU) padding module calculates a padding factor, an interleaver parameter of a binary convolutional code (BCC) interleaver module, or a mapping distance parameter of a low density parity check (LDPC) tone mapper module.

In some embodiments, determining, by the first device, according to the number of first data tones, the parameter used when the EHT PPDU padding module calculates the padding factor, includes:
determining, by the first device, a number of second data tones according to the number of first data tones and a second rule; where the number of second data tones is the parameter used when the EHT PPDU padding module calculates the padding factor;
the second rule includes at least one of:
in a case where a modulation and coding scheme (MCS) index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, where the N_ss represents a number of spatial streams, the N_{BPSCS} represents a number of coded bits per tone per spatial stream, and the R represents a coding rate.

In some embodiments, in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones is 60; and/or
in a case where a size of at least one of a virtual RU, a virtual MRU, a logical RU or a logical MRU allocated to a single STA is 242 tones and the MCS index is 15, the number of second data tones is 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones is 114; and/or
in a case where a size of at least one of a virtual RU, a virtual MRU, a logical RU or a logical MRU allocated to a single STA is 484 tones and the MCS index is 15, the number of second data tones being 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones is 234; and/or
in a case where a size of at least one of a virtual RU, a virtual MRU, a logical RU or a logical MRU allocated to a single STA is 996 tones and the MCS index is 15, the number of second data tones is 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones is 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is 84.

In some embodiments, determining, by the first device, according to the number of first data tones, the interleaver parameter of the BCC interleaver module, includes:
determining, by the first device, a column parameter of the BCC interleaver module and a row parameter of the BCC interleaver module according to the number of first data tones and a third rule;
where the third rule includes: a product of the column parameter of the BCC interleaver module and the row parameter of the BCC interleaver module being equal to a product of the number of first data tones and N_{BPSCS}, where the N_{BPSCS}, represents a number of coded bits per tone per spatial stream.

In some embodiments, in a case where a size of at least one of a virtual RU, a virtual MRU, a logical RU or a logical MRU allocated to a single STA is 242 tones and DCM is not used, the column parameter of the BCC interleaver module is 28, and the row parameter of the BCC interleaver module is 8×N_{BPSCS}; and/or
in a case where a size of at least one of a virtual RU, a virtual MRU, a logical RU or a logical MRU allocated to a single STA is 242 tones and the DCM is used, the column parameter of the BCC interleaver module is 14, and the row parameter of the BCC interleaver module is 8×N_{BPSCS}.

In some embodiments, determining, by the first device, according to the number of first data tones, the mapping distance parameter of the LDPC tone mapper module, includes:
determining, by the first device, the mapping distance parameter of the LDPC tone mapper module according to the number of first data tones and a fourth rule;
where the fourth rule includes at least one of:
the mapping distance parameter of the LDPC tone mapper module being greater than or equal to N_{CBPS}/L_{CW}, where the N_{CBPS} represents a number of coding bits per OFDM symbol, and the L_{CW} represents a length of an LDPC codeword;
in a case where DCM is not used, the mapping distance parameter of the LDPC tone mapper module being equal to N_{SD}^{v}/k; in a case where the DCM is used, the mapping distance parameter of the LDPC tone mapper module being equal to N_{SD}^{v}/2k, where N_{SD}^{v} represents the number of first data tones, and the k is an integer; or
the mapping distance parameter of the LDPC tone mapper module being constant for all MCS rates within each RU/MRU.

In some embodiments, in a case where a size of at least one of a virtual RU, a virtual MRU, a logical RU, or a logical MRU allocated to a single STA is 242 tones and the DCM is not used, the mapping distance parameter of the LDPC tone mapper module is 8; and/or
in a case where a size of at least one of a virtual RU, a virtual MRU, a logical RU, or a logical MRU allocated to a single STA is 242 tones and the DCM is used, the mapping distance parameter of the LDPC tone mapper module is 8; and/or
in a case where a size of at least one of a virtual RU, a virtual MRU, a logical RU, or a logical MRU allocated to a single STA is 484 tones and the DCM is not used, the mapping distance parameter of the LDPC tone mapper module is 14; and/or
in a case where a size of at least one of a virtual RU, a virtual MRU, a logical RU, or a logical MRU allocated to a single STA is 484 tones and the DCM is used, the mapping distance parameter of the LDPC tone mapper module is 8; and/or
in a case where a size of at least one of a virtual RU, a virtual MRU, a logical RU, or a logical MRU allocated to a single STA is 996 tones and the DCM is not used, the mapping distance parameter of the LDPC tone mapper module is 21; and/or
in a case where a size of at least one of a virtual RU, a virtual MRU, a logical RU, or a logical MRU allocated to a single STA is 996 tones and the DCM is used, the mapping distance parameter of the LDPC tone mapper module is 14; and/or
in a case where sizes of RUs in at least one of a virtual RU, a virtual MRU, a logical RU, or a logical MRU allocated to a single STA are 484 tones and 242 tones respectively, and the DCM is not used, the mapping distance parameter of the LDPC tone mapper module is 16; and/or
in a case where sizes of RUs in at least one of a virtual RU, a virtual MRU, a logical RU, or a logical MRU allocated to a single STA are 484 tones and 242 tones respectively, and the DCM is used, the mapping distance parameter of the LDPC tone mapper module is 8.

In some embodiments, a number of data virtual tones or data logical tones included in the at least one of the second virtual RU, the first virtual MRU, the first logical RU or the first logical MRU is the same as a number of data tones included in a physical RU/MRU with a same size as the at least one of the second virtual RU, the first virtual MRU, the first logical RU or the first logical MRU; and/or
a number of pilot virtual tones or pilot logical tones included in the at least one of the second virtual RU, the first virtual MRU, the first logical RU or the first logical MRU is the same as a number of pilot tones included in a physical RU/MRU with a same size as the at least one of the second virtual RU, the first virtual MRU, the first logical RU or the first logical MRU.

In some embodiments, positions of the pilot virtual tones or the pilot logical tones of the at least one of the second virtual RU, the first virtual MRU, the first logical RU or the first logical MRU are the same as positions of pilot physical tones of the physical RU/MRU with the same size as the at least one of the second virtual RU, the first virtual MRU, the first logical RU or the first logical MRU.

In some embodiments, positions of pilot physical tones of the at least one of the second virtual RU, the first virtual MRU, the first logical RU or the first logical MRU are determined by the positions of the pilot virtual tones or the pilot logical tones of the at least one of the second virtual RU, the first virtual MRU, the first logical RU or the first logical MRU, and an interleaving mode.

In some embodiments, a number of data virtual tones or data logical tones included in the at least one of the fourth virtual RU, the second virtual MRU, the second logical RU or the second logical MRU is the same as a number of data tones included in a physical RU/MRU with a same size as the at least one of the fourth virtual RU, the second virtual MRU, the second logical RU or the second logical MRU; and/or
a number of pilot virtual tones or pilot logical tones included in the at least one of the fourth virtual RU, the second virtual MRU, the second logical RU or the second logical MRU is the same as a number of pilot tones included in a physical RU/MRU with a same size as the at least one of the fourth virtual RU, the second virtual MRU, the second logical RU or the second logical MRU.

In some embodiments, positions of the pilot virtual tones or the pilot logical tones of the at least one of the fourth virtual RU, the second virtual MRU, the second logical RU or the second logical MRU are the same as positions of pilot physical tones of the physical RU/MRU with the same size as the at least one of the fourth virtual RU, the second virtual MRU, the second logical RU or the second logical MRU.

In some embodiments, positions of pilot physical tones of the at least one of the fourth virtual RU, the second virtual MRU, the second logical RU or the second logical MRU are determined by positions of the pilot virtual tones or the pilot logical tones of the at least one of the fourth virtual RU, the second virtual MRU, the second logical RU or the second logical MRU, and an interleaving mode.

In some embodiments, the method further includes:
transmitting, by the first device, an OFDMA EHT PPDU on interleaved RU, where the OFDMA EHT PPDU carries the first information.

In the embodiments, a deinterleaving method is further provided, which includes:
receiving, by a second device, an OFDMA EHT PPDU;
deinterleaving, by the second device, an interleaved resource unit (RU) according to first information carried in the OFDMA EHT PPDU, where the first information includes at least one of a bandwidth, an interleaving granularity or RU allocation information.

In some embodiments, the method further includes:
determining, by the second device, a number of first data tones and/or a number of first pilot tones according to the first information;
where the number of first data tones is a number of data virtual tones or data logical tones included in at least one of a second virtual RU, a first virtual MRU, a first logical RU or a first logical MRU; or
the number of first data tones is a number of data virtual tones or data logical tones included in at least one of a fourth virtual RU, a second virtual MRU, a second logical RU, or a second logical MRU; or
the number of first pilot tones is a number of pilot virtual tones or pilot logical tones included in at least one of a second virtual RU, a first virtual MRU, a first logical RU or a first logical MRU; or
the number of first pilot tones is a number of pilot virtual tones or pilot logical tones included in at least one of a fourth virtual RU, a second virtual MRU, a second logical RU, or a second logical MRU;
where the at least one of the second virtual RU, the first virtual MRU, the first logical RU or the first logical MRU is formed by plurality of first virtual RUs to which interleaved plurality of first physical RUs are respectively mapped, in sequence; or
the at least one of the fourth virtual RU, the second virtual MRU, the second logical RU or the second logical MRU is formed by a plurality of first virtual RUs to which interleaved plurality of first physical RUs are respectively mapped, and third virtual RUs to which a plurality of second physical RUs are respectively mapped, in sequence.

In some embodiments, in a case where a size of at least one of a virtual RU, a virtual MRU, a logical RU or a logical MRU allocated to a single STA is 242 tones, the number of first data tones is 224, and the number of first pilot tones is 18; and/or
in a case where a size of at least one of a virtual RU, a virtual MRU, a logical RU or a logical MRU allocated to a single STA is 484 tones, the number of first data tones is 448, and the number of first pilot tones is 36; and/or
in a case where a size of at least one of a virtual RU, a virtual MRU, a logical RU or a logical MRU allocated to a single STA is 996 tones, the number of first data tones is 924, and the number of first pilot tones is 72; and/or
in a case where sizes of RUs of at least one of a virtual RU, a virtual MRU, a logical RU or a logical MRU allocated to a single STA are 484 tones and 242 tones respectively, the number of first data tones is 672, and the number of first pilot tones is 54;
where the at least one of the virtual RU, the virtual MRU, the logical RU or the logical MRU allocated to the single STA is indicated by the RU allocation information.

In some embodiments, the method further includes:
determining, by the second device, according to the number of first data tones, at least one of a parameter used when an EHT PPDU padding module calculates a padding factor, an interleaver parameter of a BCC interleaver module, or a mapping distance parameter of an LDPC tone mapper module.

In some embodiments, determining, by the second device, according to the number of first data tones, the parameter used when the EHT PPDU padding module calculates the padding factor, includes:
determining, by the second device, a number of second data tones according to the number of first data tones and a second rule; where the number of second data tones is the parameter used when the EHT PPDU padding module calculates the padding factor;
the second rule includes at least one of:
in a case where an MCS index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, where the N_ss represents a number of spatial streams, the N_{BPSCS} represents a number of coded bits per tone per spatial stream, and the R represents a coding rate.

In some embodiments, in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones is 60; and/or
in a case where a size of at least one of a virtual RU, a virtual MRU, a logical RU or a logical MRU allocated to a single STA is 242 tones and the MCS index is 15, the number of second data tones is 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones is 114; and/or
in a case where a size of at least one of a virtual RU, a virtual MRU, a logical RU or a logical MRU allocated to a single STA is 484 tones and the MCS index is 15, the number of second data tones is 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones is 234; and/or
in a case where a size of at least one of a virtual RU, a virtual MRU, a logical RU or a logical MRU allocated to a single STA is 996 tones and the MCS index is 15, the number of second data tones is 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones is 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is 84.

In some embodiments, determining, by the second device, according to the number of first data tones, the interleaver parameter of the BCC interleaver module, includes:
determining, by the second device, a column parameter of the BCC interleaver module and a row parameter of the BCC interleaver module according to the number of first data tones and a third rule;
where the third rule includes: a product of the column parameter of the BCC interleaver module and the row parameter of the BCC interleaver module being equal to a product of the number of first data tones and N_{BPSCS}, where the N_{BPSCS} represents a number of coded bits per tone per spatial stream.

In some embodiments, in a case where a size of at least one of a virtual RU, a virtual MRU, a logical RU or a logical MRU allocated to a single STA is 242 tones and a DCM is not used, the column parameter of the BCC interleaver module is 28, and the row parameter of the BCC interleaver module is 8×N_{BPSCS}; and/or
in a case where a size of at least one of a virtual RU, a virtual MRU, a logical RU or a logical MRU allocated to a single STA is 242 tones and the DCM is used, the column parameter of the BCC interleaver module is 14, and the row parameter of the BCC interleaver module is 8×N_{BPSCS}.

In some embodiments, determining, by the second device, according to the number of first data tones, the mapping distance parameter of the LDPC tone mapper module, includes:
determining, by the first device, the mapping distance parameter of the LDPC tone mapper module according to the number of first data tones and a fourth rule;
where the fourth rule includes at least one of:
the mapping distance parameter of the LDPC tone mapper module being greater than or equal to N_{CBPS}/L_{CW}, where the N_{CBPS} represents a number of coding bits per OFDM symbol, and the L_{CW} represents a length of an LDPC codeword; or
in a case where DCM is not used, the mapping distance parameter of the LDPC tone mapper module being equal to N_{SD}^{v}/k; in a case where the DCM is used, the mapping distance parameter of the LDPC tone mapper module being equal to N_{SD}^{v}/2k, where N_{SD}^{v} represents the number of first data tones, and the k is an integer; and/or
the mapping distance parameter of the LDPC tone mapper module being constant for all MCS rates within each RU/MRU.

In some embodiments, in a case where a size of at least one of a virtual RU, a virtual MRU, a logical RU, or a logical MRU allocated to a single STA is 242 tones and the DCM is not used, the mapping distance parameter of the LDPC tone mapper module is 8; and/or
in a case where a size of at least one of a virtual RU, a virtual MRU, a logical RU, or a logical MRU allocated to a single STA is 242 tones and the DCM is used, the mapping distance parameter of the LDPC tone mapper module is 8; and/or
in a case where a size of at least one of a virtual RU, a virtual MRU, a logical RU, or a logical MRU allocated to a single STA is 484 tones and the DCM is not used, the mapping distance parameter of the LDPC tone mapper module is 14; and/or
in a case where a size of at least one of a virtual RU, a virtual MRU, a logical RU, or a logical MRU allocated to a single STA is 484 tones and the DCM is used, the mapping distance parameter of the LDPC tone mapper module is 8; and/or
in a case where a size of at least one of a virtual RU, a virtual MRU, a logical RU, or a logical MRU allocated to a single STA is 996 tones and the DCM is not used, the mapping distance parameter of the LDPC tone mapper module is 21; and/or
in a case where a size of at least one of a virtual RU, a virtual MRU, a logical RU, or a logical MRU allocated to a single STA is 996 tones and the DCM is used, the mapping distance parameter of the LDPC tone mapper module is 14; and/or
in a case where sizes of RUs in at least one of a virtual RU, a virtual MRU, a logical RU, or a logical MRU allocated to a single STA are 484 tones and 242 tones respectively, and the DCM is not used, the mapping distance parameter of the LDPC tone mapper module is 16; and/or
in a case where sizes of RUs in at least one of a virtual RU, a virtual MRU, a logical RU, or a logical MRU allocated to a single STA are 484 tones and 242 tones respectively, and the DCM is used, the mapping distance parameter of the LDPC tone mapper module is 8.

The technical solutions in the embodiments of the present disclosure may be applied to various communication systems, such as: Wireless Local Area Networks (WLAN), Wireless Fidelity (WiFi) or other communication systems.

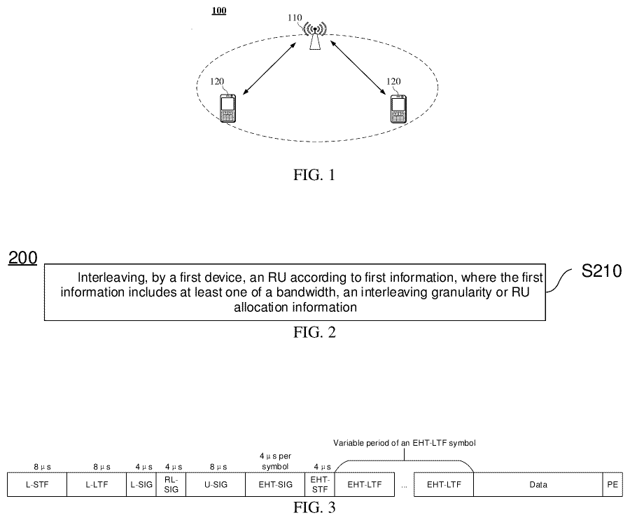

Exemplarily, a communication system 100 applied by the embodiments of the present disclosure is as shown in FIG. 1. The communication system 100 may include an access point (AP) 110 and a station (STA) 120 accessing a network via the access point 110.

In some scenarios, the AP is alternatively referred to as an AP STA, that is, in a sense, the AP is also a STA.

In some scenarios, the STA is alternatively referred to as a non-AP STA.

The communication in the communication system 100 may be communication between an AP and a non-AP STA, or may also be communication between a non-AP STA and a non-AP STA, or communication between an STA and a peer STA, where the peer STA may refer to a device that communicates with an STA end to end, for example, the peer STA may be an AP or may be also a non-AP STA.

AP is equivalent to a bridge for connecting a wired network with a wireless network, and has a main function of connecting respective wireless network clients together and then make the wireless network access to Ethernet. An AP device may be a terminal device (such as a mobile phone) or a network device (such as a router) with a WiFi chip.

It should be understood that, a role of the STA in the communication system is not absolute, for example, in some scenarios, when a mobile phone is connected to a router, the mobile phone is a non-AP STA, and in a case where the mobile phone serves as a hotspot for other mobile phones, the mobile phone plays a role of an AP.

The AP and the non-AP STA may be devices applied in Internet of Vehicles; Internet of Things nodes and sensors in the Internet of Things (IoT); smart cameras, smart remote controls, smart water and electricity meters in smart homes; and sensors in smart cities, etc.

In some embodiments, the non-AP STA may support an 802.11be standard. The non-AP STA may also support various current and future 802.11 family of wireless local area networks (WLAN) standards, such as 802.11ax, 802.11ac, 802.11n, 802.11g, 802.11b and 802.11a, etc.

In some embodiments, the AP may be a device supporting the 802.11be standard. The AP may also be a device supporting various current and future 802.11 family of WLAN standards, such as 802.11ax, 802.11ac, 802.11n, 802.11g, 802.11b, and 802.11a, etc.

In the embodiments of the present disclosure, the STA may be a mobile phone, a pad, a computer, a virtual reality (VR) device, an augmented reality (AR) device, a wireless device in industrial control, a set-top box, a wireless device in self-driving, a vehicle-mounted communication device, a wireless device in remote medical, a wireless device in a smart grid, a wireless device in transportation safety, a wireless device in a smart city or a wireless device in a smart home, a wireless communication chip/application specific integrated circuit (ASIC)/system-on-chip (SOC)/etc., which support the WLAN/WiFi technology.

Frequency bands which may be supported by the WLAN technology, may include but be not limited to: low frequency bands (for example, 2.4 GHz, 5 GHz, and 6 GHz) and high frequency bands (for example, 60 GHz).

FIG. 1 exemplarily illustrates one AP STA and two non-AP STAs, and optionally, the communication system 100 may include a plurality of AP STAs and include other numbers of non-AP STAs, which is not limited in the embodiments of the present disclosure.

It should be understood that, the terms “system” and “network” herein are often used interchangeably herein. The term “and/or” herein is merely to describe an association relationship of associated objects, representing that there may be three relationships, such as A and/or B which may represent three relationships: A alone, A and B both, and B alone. In addition, a character “/” herein generally represents that associated objects before and after “/” are in a relationship of “or”.

It should be understood that, the “indication” mentioned in the embodiments of the present disclosure may be a direct indication, an indirect indication, or an indication of an associated relationship. For example, A indicating B may represent that A directly indicates B, for example, B may be obtained through A; A indicating B may also represent that A indirectly indicates B, for example, A indicates C, B may be obtained through C; A indicating Bit may also represent that there is an association relationship between A and B.

In the description of the embodiments of the present disclosure, the term “corresponding” may represent a direct or indirect correspondence between two items, may represent an association relationship between the two items, or may represent a relationship of indication and being indicated, configuration and being configured, etc.

To facilitate understanding of the technical solutions of the embodiments of the present disclosure, the related technologies of the embodiments of the present disclosure are described below, and the following related technologies as optional solutions may be randomly combined with the technical solutions of the embodiments of the present disclosure, which all belong to the protection scope of the embodiments of the present disclosure.

FIG. 2 is a schematic flowchart of an interleaving method 200 according to an embodiment of the present disclosure. The method may optionally be applied to the system shown in FIG. 1, but not limited thereto. The method includes at least some of the following content.

S210: interleaving, by a first device, an RU according to first information, where the first information includes at least one of a bandwidth, an interleaving granularity or RU allocation information.

In some implementations, the above first device is an AP or an STA.

In an implementation, the first device transmits an OFDMA EHT PPDU on an interleaved RU.

The EHT PPDU has two forms: EHT multi-user (MU) PPDU and EHT trigger based (TB) PPDU. Herein, a format of the EHT MU PPDU is shown in FIG. 3, and may be used to be transmitted to one or more users (e.g., STA). In the EHT MU PPDU, a non-HT short training field (L-STF), a non-HT long training field (L-LTF), a non-HT signal field (L-SIG), a universal signal field (U-SIG) and an EHT signal field (EHT-SIG) are referred to as pre-EHT modulation fields; and an EHT short training field (EHT-STF), an EHT long training field (EHT-LTF), a data and packet Extension field (PE) are referred to as EHT modulation fields.

In the embodiments of the present disclosure, when the OFDMA EHT PPDU transmission is performed, RU interleaving may be performed at a transmitting end, and deinterleaving may be performed at a receiving end. The above first device in the embodiments of the present disclosure may be a transmitting end for the OFDMA EHT PPDU, and after the transmitting end transmits the OFDMA EHT PPDU, the receiving end (such as a second device) receives the OFDMA EHT PPDU and performs deinterleaving.

The U-SIG and EHT-SIG in the OFDMA EHT PPDU may carry the above first information, such as at least one of the bandwidth (or referred to as a PPDU bandwidth), the interleaving granularity (or referred to as an RU interleaving granularity), or the RU allocation information. Herein, the RU allocation information may indicate which tones on which RU are specially used to transmit data. Before transmitting the OFDMA EHT PPDU, the first device may also determine a relevant data field parameter according to the above first information, and process transmission data according to the data field parameter. After receiving the OFDMA EHT PPDU, the second device may deinterleave the interleaved RU according to the first information carried in the OFDMA EHT PPDU, determine the relevant data field parameter according to the first information, and process the received data according to the data field parameter. The above data field parameter may include at least one of a parameter used when an EHT PPDU padding module calculates a padding factor, an interleaver parameter of a binary convolutional code (BCC) interleaver module, or a mapping distance parameter of a low-density parity check (LDPC) tone mapper module.

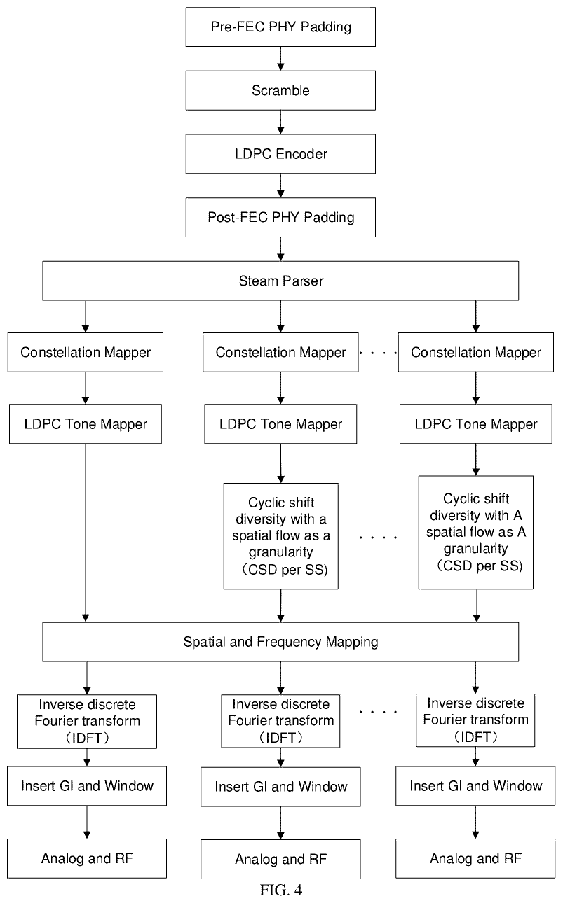

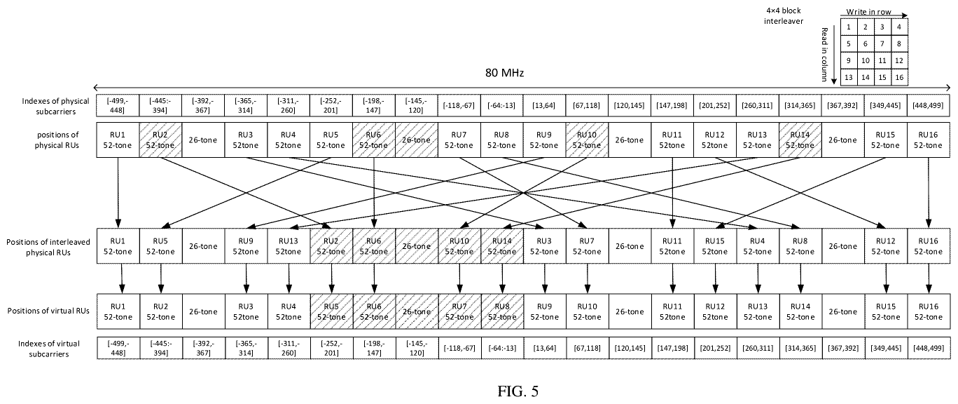

In some implementations, when the OFDMA EHT PPDU is generated, the RU interleaving occurs in spatial mapping and frequency domain mapping stages. The spatial mapping is to map a spatial stream onto a corresponding radio frequency (RF) link. The frequency domain mapping is to map a modulation symbol onto a corresponding physical tone, for each RF link. In some embodiments, for each RF link, the frequency domain mapping includes two steps: first, mapping the modulation symbol to a virtual tone, and then mapping the virtual tone to a physical tone. FIG. 4 is a schematic diagram of a UL or DL non-MU-MIMO transmission process of a data domain using LDPC encoding, when the RU or MRU is less than or equal to 996 tones (or referred to as 996 channels or 996-tone), in an interleaving method according to an embodiment of the present disclosure. As shown in FIG. 4, the interleaving process proposed in the embodiments of the present disclosure is performed in the spatial and frequency mapping process.

In the related art, 8 types of RUs are defined, and an MRU formed by multiple RUs is defined at the same time. 1 RU or MRU may be allocated to 1 STA, especially as follows.

### (1) RU:

a RU used for uplink and downlink OFDMA transmission in the EHT PPDU is defined as follows: a 26-tone RU (or referred to as an RU with a size of 26 tones, an RU with a size of 26 channels; and names of RUs with other sizes are similar and will not be repeated), a 52-tone RU, a 106-tone RU, 242-tone RU, a 484-tone RU, a 996-tone RU, and a 2×996-tone RU.

RUs are divided into large-size RUs and small-size RUs:
where the large-size RUs are RUs with a size greater than or equal to 242-tone, including a 242-tone RU, a 484-tone RU, a 996-tone RU and a 2×996-tone RU;
the small-size RUs are RUs with a size smaller than 242-tone, including a 26-tone RU, a 52-tone RU, and a 106-tone RU.

The small-size RUs may be used in 20 MHz, 40 MHz, 80 MHz, 160 MHz or 320 MHz OFDMA EHT PPDU; the 242-tone RU may be used in a 40 MHz, 80 MHz, 160 MHz or 320 MHz OFDMA EHT PPDU; the 484-tone RU may be used in an 80 MHz, 160 MHz or 320 MHz OFDMA EHT PPDU; the 996-tone RU may be used in a 160 MHz or 320 MHz OFDMA EHT PPDU; and the 2×996-tone RU may be used in a 320 MHz OFDMA EHT PPDU.

### (2) MRU:

a small-size RU may only be combined with a small-size RU to form a small-size MRU; and a large-size RU may only be combined with a large-size RU to form a large-size MRU. The examples are as follows.

### (2-1) Small-Size MRU:

a small-size MRU for the uplink and downlink OFDMA transmission in the EHT PPDU is defined as follows: a 52+26-tone MRU (representing an MRU formed by combining a 52-tone RU and a 26-tone RU; and meanings of MRUs with other sizes are similar and will not be repeated) and a 106+26-tone MRU. The 52-tone RU and the 26-tone RU in any one 52+26-tone MRU need to be from a same 20 MHz sub-channel. A 106-tone RU and a 26-tone RU in any one 106+26-tone MRU need to be from a same 20 MHz sub-channel.

### (2-2) Large-Size MRU:

a large-size MRU for the uplink and downlink OFDMA transmission in the EHT PPDU is defined as follows: a 484+242-tone MRU, a 996+484-tone MRU, a 2×996+484-tone MRU, a 3×996-tone MRU, and a 3×996+484-tone MRU.

The 484+242-tone MRU is allowed to be used in 80 MHz, 160 MHz and 320 MHz OFDMA EHT PPDUs, and the 484-tone RU and the 242-tone RU in any one 484+242-tone MRU need to be from a same 80 MHz sub-channel;
the 996+484-tone MRU is allowed to be used in 160 MHz and 320 MHz OFDMA EHT PPDUs; and the 996-tone RU and the 484-tone RU in any one 996+484-tone MRU need to be from a same 160 MHz sub-channel;
the 2×996+484-tone MRU, the 3×996-tone MRU, and the 3×996+484-tone MRU are allowed to be used in a 320 MHz OFDMA EHT PPDU. And, the 996-tone RUs and the 484-tone RU in any one 2×996+484-tone MRU need to be from three continuous 80 MHz sub-channels.

According to the sizes of the RU or the MRU and in combination with the allocation method of the RU or the MRU, the embodiments of the present disclosure at least provide the following interleaving method, including:
method one: in a case where the interleaving granularity is 26 tones (or 26-tone), interleaving, by the first device, the RU according to the first information, includes:
dividing, by the first device, the bandwidth into a plurality of first physical RUs according to the interleaving granularity, where a size of the first physical RU is the same as a size of the interleaving granularity;
interleaving the plurality of first physical RUs according to a rule of an interleaver;
mapping interleaved plurality of first physical RUs to corresponding first virtual RUs respectively, where a plurality of the first virtual RUs form at least one of a second virtual RU, a first virtual MRU, a first logical RU or a first logical MRU, in sequence. In some implementations, the second virtual RU/the first virtual MRU/the first logical RU/the first logical MRU includes a plurality of first virtual RUs, and the second virtual RU/the first virtual MRU/the first logical RU/the first logical MRU is formed by the plurality of first virtual RUs in sequence.

In the embodiments of the present disclosure, a minimum interleaving unit may be referred to as a “reference RU”, the above first physical RU may be referred to as a physical reference RU, and the above first virtual RU may be referred to as a virtual reference RU.

For example, the RU interleaving granularity g is equal to 26 tones, and the interleaving method includes the following process:
(a) dividing the bandwidth (BW) into N_{g} physical reference RUs according to the interleaving granularity g, and marking each physical reference RU as 1, 2, . . . , N_{g}, respectively (a specific value of N_{g} will be introduced in a subsequent table 1).
(b) interleaving the N_{g} physical reference RUs according to the rule of the interleaver, where the interleaver may be a block interleaver or other types of interleavers, such as a triangle interleaver, a spiral interleaver or a ladder interleaver.
(c) mapping interleaved physical reference RUs to corresponding virtual reference RUs, respectively; respective virtual reference RUs form a virtual RU/MRU (or a logical RU/MRU), in sequence.

Method two: in a case where the interleaving granularity of 52 tones (or 52-tone), interleaving, by the first device, the RU according to the first information, includes:
dividing, by the first device, the bandwidth into a plurality of first physical RUs and at least one second physical RU according to the interleaving granularity, where a size of the first physical RU is the same as a size of the interleaving granularity, and a size of the second physical RU is 26 tones;
interleaving the plurality of first physical RUs according to a rule of an interleaver; and
mapping interleaved plurality of first physical RUs to corresponding first virtual RUs respectively, and mapping a plurality of second physical RUs to corresponding third virtual RUs respectively, where a plurality of the first virtual RUs and the third virtual RUs form at least one of a fourth virtual RU, a second virtual MRU, a second logical RU or a second logical MRU, in sequence.

In some implementations, the fourth virtual RU/the second virtual MRU/the second logical RU/the second logical MRU includes a plurality of first virtual RUs and a plurality of third virtual RUs, and the fourth virtual RU/the second virtual MRU/the second logical RU/the second logical MRU are formed by the plurality of first virtual RUs and the plurality of third virtual RUs, in sequence.

The above first physical RU may be referred to as a physical reference RU, the first virtual RU may be referred to as a virtual reference RU, and the first physical RU is an RU participating in the interleaving. The above second physical RU is an RU not participating in the interleaving.

For example, the RU interleaving granularity g is equal to 52 tones, and the interleaving method includes the following process:
(a) dividing the bandwidth (BW) into N_{g} physical reference RUs and N₂₆₋ₜₒₙₑ 26-tone RUs according to the interleaving granularity g, and marking respective physical reference RUs as 1, 2, . . . , N_{g} (specific values of N_{g} and N₂₆₋ₜₒₙₑ will be introduced in the subsequent table 1).
(b) interleaving N_{g} physical reference RUs according to the rule of the interleaver, where the interleaver may be a block interleaver or other types of interleavers, such as a triangle interleaver, a spiral interleaver or a ladder interleaver. The N₂₆₋ₜₒₙₑ 26-tone RUs are not interleaved.
(c) mapping interleaved physical reference RUs to corresponding virtual reference RUs respectively, and mapping the N₂₆₋ₜₒₙₑ 26-tone RUs to corresponding second virtual RUs respectively, where respective virtual reference RUs and the second virtual RUs form a virtual RU/MRU (or a logical RU/MRU), in sequence.

In the above two methods, the numbers such as “first”, “second”, etc., in the second virtual RU/the first virtual MRU/the first logical RU/the first logical MRU and the fourth virtual RU/the second virtual MRU/the second logical RU/the second logical MRU are only used to distinguish the names, where the second virtual RU/the first virtual MRU/the first logical RU/the first logical MRU represents a RU/MRU formed by the virtual RUs to which the interleaved physical RU are mapped, and the fourth virtual RU/the second virtual MRU/the second logical RU/the second logical MRU represents a RU/MRU formed by the virtual RUs to which the interleaved physical RUs are mapped and the virtual RUs to which the physical RUs not participating in the interleaving are mapped. In the following embodiments, for the convenience of description, “virtual RU/virtual MRU/logical RU/logical MRU” or “at least one of virtual RU, virtual MRU, logical RU or logical MRU” may not only refer to the above second virtual RU/first virtual MRU/first logical RU/first logical MRU, but also refer to the above fourth virtual RU/second virtual MRU/second logical RU/second logical MRU.

Exemplary values of the above N_{g} and N₂₆₋ₜₒₙₑ are as shown in table 1.

TABLE 1
the number of interleaved RUs of different bandwidths corresponding
to different RU interleaving granularities

| RU | the number of interleaved RUs corresponding to different RU interleaving | | |
|---|---|---|---|
| interleaving | granularities | | |
| granularity | Bandwidth = 80 MHz | Bandwidth = 160 MHz | Bandwidth = 320 MHz |
| 26-tone | N_{g} = 36 | N_{g} = 72 | N_{g} = 144 |
| 52-tone | N_{g} = 16 and N₂₆₋ₜₒₙₑ = 4 | N_{g} = 3 and N₂₆₋ₜₒₙₑ = 8 | N_{g} = 64 and N₂₆₋ₜₒₙₑ = 16 |

As shown in table 1, for example, in a case where the bandwidth is 80 megahertz (MHz) and the interleaving granularity is 26-tone, the 80 MHz bandwidth is divided into 36 physical reference RUs, and each physical reference RU participates in the interleaving. For another example, in a case where the bandwidth is 80 MHz and the interleaving granularity is 52-tone, the 80 MHz bandwidth is divided into 16 physical reference RUs and 4 26-tone RUs, each physical reference RU participates in the interleaving, and the 4 26-tone RUs do not participate in the interleaving. The interpretation of the remaining data is similar to the interpretation of the above data and will not be repeated here.

FIG. 5 is a schematic diagram of RU interleaving according to an embodiment of the present disclosure. FIG. 5 shows an interleaving example with a bandwidth of 80 MHz and an interleaving granularity of 52-tone in a case of no punctured channel. The interleaving example shown in FIG. 5 adopts a 4×4 block interleaver, referring to the above table 1, BW=80 MHz, g=52-tone, N_{g}=16, and N₂₆₋ₜₒₙₑ=4; that is, the 80 MHz bandwidth is divided into 16 physical 52-tone RUs and 4 26-tone RUs according to the interleaving granularity of 52-tone, the 16 physical 52-tone RUs are interleaved according to the rule of the 4×4 block interleaver, and positions of interleaved physical 52-tone RUs are mapped to positions of virtual 52-tone RUs. Positions of 4 26-tone RUs are mapped to positions of virtual 26-tone RUs, respectively.

It is assumed that 1 virtual 242-tone RU is allocated to 1 STA (shaded parts of virtual RU positions in FIG. 5, including four first virtual RUs with a size of 52-tone RU and one second virtual RU with a size of 26-tone). Numbers of the 4 first virtual RUs are RU5, RU6, RU7, and RU8, respectively.

As shown in FIG. 5, the virtual 52-tone RU5 corresponds to the physical 52-tone RU2, the position of the virtual tone of the virtual 52-tone RU5 is [−252, −201], and the position of the physical tone of the physical 52-tone RU2 is [−445, −394]. The virtual 52-tone RU6 corresponds to the physical 52-tone RU6, the position of the virtual tone of the virtual 52-tone RU6 is [−198, −147], and the position of the physical tone of the physical 52-tone RU6 is [−198, −147]. The virtual 26-tone RU is not interleaved. The virtual 52-tone RU7 corresponds to the physical 52-tone RU10, the position of the virtual tone of the virtual 52-tone RU7 is [−118, −67], and the position of the physical tone of the physical 52-tone RU10 is [67,118]. The virtual 52-tone RU8 corresponds to the physical 52-tone RU14, the position of the virtual tone of the virtual 52-tone RU8 is [−64, −13], and the position of the physical tone of the physical 52-tone RU14 is [314, 365].

In the embodiments of the present disclosure, “virtual” may be equivalent to “logical”, a virtual RU/MRU may also be referred to as a logical RU/MRU, a virtual tone may also be referred to as a logical tone, a pilot virtual tone may also be referred to as a pilot logical tone, a data virtual tone may also be referred to as a data logical tone, etc.

The purpose of the RU interleaving proposed in the embodiments of the present disclosure is to increase the frequency diversity gain of each STA by using the RU interleaving, in a case of the large-bandwidth OFDMA EHT PPDU transmission involving a plurality of STAs. According to a using scenario of the RU interleaving, in combination with the RU size and the RU allocation mode in the related art, and by weighing a relationship between the implementation complexity and the RU interleaving gain, the embodiments of the present disclosure propose the using rule of the RU interleaving, for example, in a case where a first rule is satisfied, the first device interleaves the RU according to the above first information; the first rule includes at least one of:
the interleaving granularity being 26 tones or 52 tones;
the bandwidth being greater than or equal to a preset bandwidth threshold;
at least one of a virtual RU, a virtual MRU, a logical RU or a logical MRU allocated to a single STA being a large-size RU/MRU;
a size of at least one of a virtual RU, a virtual MRU, a logical RU or a logical MRU allocated to a single STA being greater than or equal to M reference RUs, where the M is a positive integer, and the reference RU is a minimum interleaving unit;
a size of at least one of a virtual RU, a virtual MRU, a logical RU or a logical MRU allocated to a single STA being less than or equal to 1/N of a size of a bandwidth RU corresponding to the bandwidth, where the N is a positive integer;
a reduction rate of a number of data virtual tones or data logical tones included in at least one of a virtual RU, a virtual MRU, a logical RU or a logical MRU to a number of data tones included in a physical RU/MRU with a same size as the at least one of the virtual RU, the virtual MRU, the logical RU or the logical MRU, being less than or equal to a preset value; or
performing OFDMA transmission;
where the at least one of the virtual RU, the virtual MRU, the logical RU or the logical MRU allocated to the single STA is indicated by the RU allocation information.

In some embodiments, the above preset bandwidth threshold may be 40 MHz; and/or,
the above preset bandwidth threshold may be 40 MHz; and/or,
the above large-size RU may be an RU including 242 tones, 484 tones, 996 tones or 2×996 tones; and/or
the above large-size MRU may include at least two large-size RUs; and/or
the above M may be 2 or 3; and/or
the above N may be 4; and/or
the above preset value may be 10%.

For example, the above interleaving rule includes at least one of the following.

(1) The RU interleaving granularity may be 26-tone, or 52-tone.

Rule (1) is a limitation on the interleaving granularity. If the interleaving granularity is too large, the number of physical RUs participating in the interleaving is smaller, so that the frequency diversity gain for each STA is smaller; if the interleaving granularity is too small, the complexity of the interleaving processing will increase. The interleaving granularity is set to 26-tone or 52-tone in the embodiments of the present disclosure, by weighing the foregoing.

(2) When the bandwidth is less than or equal to B MHz, for example, B=40, an RU interleaving mode is not used.

Rule (2) is a limitation on the bandwidth. If the bandwidth is too small, the number of physical RUs participating in the interleaving is smaller, so that the frequency diversity gain for each STA is smaller. Considering the foregoing, a minimum bandwidth for using the interleaving mode is set in the embodiments of the present disclosure.

(3) When the virtual RU/MRU (or the logical RU/MRU) allocated to 1 STA is a small-size RU or MRU, the RU interleaving mode is not used.

(4) When the virtual RU/MRU (or the logical RU/MRU) allocated to 1 STA is less than M reference RUs, for example, M=2 or 3, the RU interleaving mode is not used.

(5) When the RU or MRU allocated to 1 STA is greater than 1/N of the bandwidth RU (including unpunctured and punctured cases), for example, N=4, the RU interleaving mode is not used.

Rules (3), (4), and (5) are limitations on the size of the virtual RU/MRU allocated to a single STA, if the size of the virtual RU/MRU allocated to the single STA is too small, or a proportion of the virtual RU/MRU allocated to the single STA in the entire bandwidth is too large, the number of physical RUs participating in the interleaving is smaller, so that the frequency diversity gain for each STA is smaller, and therefore, there is no need to adopt the interleaving mode; if the virtual RU/MRU allocated to the single STA is not larger than the reference RU, the interleaving cannot be performed.

For example: in a case of an unpunctured channel, the bandwidth is 80 MHz, then a bandwidth RU corresponding to the bandwidth (i.e., a maximum RU size that can be allocated within the entire bandwidth) is 996-tone, and if the virtual RU/MRU allocated to one STA is 484-tone, the virtual RU/MRU allocated to one STA occupies too large proportion in the entire bandwidth, and the RU interleaving mode cannot be used. For another example, in a case of a punctured channel, the bandwidth is 80 MHz and a first 20 MHz sub-channel is punctured, then the bandwidth RU is 484+242 tone; if the virtual RU/MRU allocated to one STA is 242-tone, the virtual RU/MRU allocated to one STA occupies a too large proportion in the entire bandwidth, and the RU interleaving mode cannot be used.

(6) When a reduction rate a of data tones exceeds a threshold ϕ, for example, ϕ=10%, the RU interleaving mode is not used.

Since the RU interleaving will cause a reduction in the data tones, the reduction amount in the data tones will have an unfavorable effect on the system performance; therefore, in the embodiments of the present disclosure, the above threshold ϕ is set by weighing the frequency diversity gain brought by the RU interleaving (belonging to a favorable effect) and the reduction in the data tones (belonging to an unfavorable effect). When the reduction rate a of the data tones exceeds the threshold ϕ, it is considered that the unfavorable effect on the system performance is too large, and thus, the RU interleaving mode is not used.

(7) When a non-OFDMA transmission is performed, the RU interleaving mode is not used.

By using the above interleaving rules and selecting relevant parameters in the above interleaving rules, such as B=40, M=2, N=4, and ϕO=10%, a situation where the RU may be interleaved can be obtained. Table 2 shows some situations where the RU may be interleaved in a case where the RU interleaving granularity is 26-tone or 52-tone.

TABLE 2

| Bandwidth (MHz) | RU or MRU (tone) |
|---|---|
| 80 | 242 |
| 160 | 242, 484 |
| 320 | 242, 484, 484 + 242, 996 |

As shown in table 2, in a case where the RU interleaving granularity is 26-tone or 52-tone, if the bandwidth is 80 MHz and the virtual RU/MRU (or the logical RU/MRU) allocated to 1 STA is 242-tone, the RU may be interleaved. Taking a second row of data in table 2 as an example, referring to the above rules, the RU interleaving granularity being 26-tone or 52-tone satisfies the rule (1). The bandwidth being 80 MHz satisfies the rule (2). The virtual RU/MRU (or the logical RU/MRU) allocated to 1 STA being 242-tone, which is a large-size RU, satisfies the rule (3). The reference RU refers to a minimum interleaving unit, and a size of the reference RU is 26-tone or 52-tone, and when M=2, a size of M reference RUs is 52-tone or 104-tone; the virtual RU/MRU (or the logical RU/MRU) allocated to 1 STA is 242-tone, which is greater than 52-tone or 104-tone, and thus the rule (4) is satisfied. When the bandwidth is 80 MHz, the corresponding bandwidth RU is 996-tone; when N=4, 1/N of the bandwidth RU is 249-tone; the virtual RU/MRU (or the logical RU/MRU) allocated to 1 STA is 242-tone, which is smaller than 249-tone, and thus the rule (5) is satisfied. The rule (6) will be analyzed in detail in the following content regarding the reduction amount and the reduction rate of the data tones.

When different RU interleaving granularities are selected to construct the virtual RU/MRU (or the logical RU/MRU), the number of data tones (such as data virtual tones or data logical tones) and pilot tones (such as pilot virtual tones or pilot logical tones) contained in the virtual RU/MRU (or the logical RU/MRU) may change.

When one RU interleaving granularity is selected to construct the virtual RU/MRU (or the logical RU/MRU), the virtual RU/MRU (or the logical RU/MRU) corresponds to a plurality of reference RU/MRUs participating in the RU interleaving and/or RUs not participating in the RU interleaving and/or tones not belong to any RU. For example, when an RU with the RU interleaving granularity of 26-tone is selected to construct the virtual 242-tone RU, the virtual 242-tone RU corresponds to 9 26-tone RUs participating in the RU interleaving and 8 tones not participating in the RU interleaving and not belonging to any RU.

The virtual RU/MRU (or the logical RU/MRU) may have a different number of data tones and pilot tones than the physical RU/MRU with the same size as the virtual RU/MRU (or the logical RU/MRU); or may have the same number of data tones and pilot tones as the virtual RU/MRU (or the logical RU/MRU). The two cases are introduced below, respectively.

### Case One:

the virtual RU/MRU (or the logical RU/MRU) has a different number of data tones and pilot tones than the physical RU/MRU with the same size. That is, the number of data virtual tones or data logical tones contained in at least one of the virtual RU, the virtual MRU, the logical RU or the logical MRU is different from the number of data tones contained in the physical RU/MRU with the same size; and/or
the number of pilot virtual tones or pilot logical tones contained in at least one of the virtual RU, the virtual MRU, the logical RU or the logical MRU is different from the number of pilot tones contained in the physical RU/MRU with the same size.

In some implementations, positions of pilot physical tones of at least one of the virtual RU, the virtual MRU, the logical RU or the logical MRU are the same as positions of pilot physical tones of the plurality of first physical RUs (i.e., the physical RUs participating in the interleaving) (in this case, the bandwidth is divided into the plurality of first physical RUs, such as the example in which the RU interleaving granularity is 26-tone); and/or
positions of pilot physical tones of at least one of the virtual RU, the virtual MRU, the logical RU or the logical MRU are the same as positions of pilot physical tones of the plurality of first physical RUs (i.e., physical RUs participating in the interleaving) and at least one second physical RU (i.e., physical RUs not participating in the interleaving) (in this case, the bandwidth is divided into the plurality of first physical RUs and the at least one second physical RU, such as the example in which the RU interleaving granularity is 52-tone).

Taking the interleaving example shown in FIG. 5 as an example, positions of pilot physical tones of a virtual 242-tone RU (shaded parts of the virtual RU positions in the figure) correspond to pilot physical tone positions {−440, −426, −414, −400} of the physical 52-tone RU2, pilot physical tones positions {−192, −178, −166, −152} of the physical 52-tone RU6, pilot physical tones positions {72, 86, 98, 112} of the physical 52-tone RU10, pilot physical tone positions {320, 334, 346, 360} of the physical 52-tone RU14, and pilot physical tone positions {−140, −126} of the physical 26-tone RU not participating in the interleaving.

The number of the pilot virtual tones or the pilot logical tones of the virtual RU/MRU (or the logical RU/MRU) is equal to a sum of the number of the pilot tones of respective reference RUs (such as physical reference RUs) participating in the RU interleaving and the number of the pilot tones of RUs (such as physical RUs) not participating in the RU interleaving; the number of the data virtual tones or the data logical tones of the virtual RU/MRU (or the logical RU/MRU) is equal to the total number of tones of the virtual RU/MRU minus the number of pilot tones of the virtual RU/MRU. Therefore, the first device can determine the number of the reference RUs participating in the RU interleaving and the number of RUs not participating in the RU interleaving (such as the information contained in the above table 1) according to the above first information; and determine a number of the pilot virtual tones or the pilot logical tones of the virtual RU/MRU (or logical RU/MRU) according to a number of the pilot tones contained in the RUs with different sizes and with the number; and then determine the data virtual tones or the data logical tones of the virtual RU/MRU (or the logical RU/MRU).

Therefore, the interleaving method proposed in the embodiments of the present disclosure may further include:
determining, by the first device, a number of first data tones and/or a number of first pilot tones according to the first information;
where the number of first data tones is the number of the data virtual tones or the data logical tones included in the at least one of the virtual RU, the virtual MRU, the logical RU or the logical MRU; or
the number of first pilot tones is the number of the pilot virtual tones or the pilot logical tones included in the at least one of the virtual RU, the virtual MRU, the logical RU or the logical MRU.

For example, when an RU (including 24 data tones and 2 pilot tones) with the RU interleaving granularity of 26-tone is selected to construct the virtual 242-tone RU, since the virtual 242-tone RU corresponds to 9 26-tone RUs participating in the RU interleaving and 8 tones not participating in the RU interleaving and not belonging to any RU, the virtual 242-tone RU includes 2×9=18 pilot virtual tones/pilot logical tones and 242−18=224 data virtual tones/data logical tones.

For another example, when an RU (including 48 data tones and 4 pilot tones) with the RU interleaving granularity of 52-tone is selected to construct the virtual 242-tone RU, since the virtual 242-tone RU corresponds to 4 52-tone RUs participating in the RU interleaving and 1 26-tone RU (including 24 data tones and 2 pilot tones) not participating in the RU interleaving and 8 tones not belonging to any RU, the virtual 242-tone RU includes 4×4+2×1=18 pilot virtual tones/pilot logical tones and 224 data virtual tones/data logical tones.

Table 3 shows a comparison of the number of data tones and the number of pilot tones contained in the physical RU/MRU with the number of data tones and the number of pilot tones contained in the virtual RU/MRU (or the logical RU/MRU) with the same size as the physical RU/MRU, when the RU interleaving granularity is 26-tone.

TABLE 3

| | Physical RU/MRU | | Virtual RU/MRU (or logical RU/MRU) | | Reduction rate of |
|---|---|---|---|---|---|
| RU/MRU size | Number of data tones N_{SD}^{p} | Number of pilot tones N_{SP}^{p} | Number of data virtual tones/Number of data logical tones N_{SD}^{v} | Number of pilot virtual tones/Number of pilot logical tones N_{SP}^{v} | $\begin{matrix}data tones \\ α = \frac{{N}_{S D}^{p} - {N}_{S D}^{v}}{{N}_{S D}^{p}}\end{matrix}$ |
| 242-tone | 234 | 8 | 242 − 18 = 224 | 2 × 9 = 18 | 0.04 |
| 484-tone | 468 | 16 | 484 − 36 = 448 | 2 × 18 = 36 | 0.04 |
| 996-tone | 980 | 16 | 996 − 72 = 924 | 2 × 36 = 72 | 0.06 |
| 484 + 242- | 702 | 24 | 484 + 242 − 54 = | 2 × 27 = 54 | 0.04 |
| tone | | | 672 | | |

Table 4 shows a comparison of the number of data tones and the number of pilot tones contained in the physical RU/MRU with the number of data tones and the number of pilot tones contained in the virtual RU/MRU (or the logical RU/MRU) with the same size as the physical RU/MRU, when the RU interleaving granularity is 52-tone.

TABLE 4

| | Physical RU/MRU | | Virtual RU/MRU (or logical RU/MRU) | | Reduction rate of |
|---|---|---|---|---|---|
| RU/MRU size | Number of data tones N_{SD}^{p} | Number of pilot tones N_{SP}^{p} | Number of data virtual tones/Number of data logical tones N_{SD}^{v} | Number of pilot virtual tones/Number of pilot logical tones N_{SP}^{v} | $\begin{matrix}data tones \\ α = \frac{{N}_{S D}^{p} - {N}_{S D}^{v}}{{N}_{S D}^{p}}\end{matrix}$ |
| 242-tone | 234 | 8 | 242 − 18 = 224 | 4 × 4 + 2 × 1 = 18 | 0.04 |
| 484-tone | 468 | 16 | 484 − 36 = 448 | 4 × 8 + 2 × 2 = 36 | 0.04 |
| 996-tone | 980 | 16 | 996 − 72 = 924 | 4 × 16 + 2 × 4 = | 0.06 |
| | | | | 72 | |
| 484 + 242- | 702 | 24 | 484 + 242 − 54 = | 4 × 12 + 2 × 3 = | 0.04 |
| tone | | | 672 | 54 | |

It can be seen from table 3 and table 4 that, in a case where a size of at least one of the virtual RU, the virtual MRU, the logical RU or the logical MRU allocated to a single STA is 242 tones, the number of first data tones (i.e., the number of the data virtual tones or the data logical tones contained in at least one of the virtual RU, the virtual MRU, the logical RU or the logical MRU) is 224, the number of first pilot tones (i.e., the number of the pilot virtual tones or the pilot logical tones contained in at least one of the virtual RU, the virtual MRU, the logical RU or the logical MRU) is 18; and/or
in a case where a size of at least one of the virtual RU, the virtual MRU, the logical RU or the logical MRU allocated to a single STA is 484 tones, the number of first data tones is 448, and the number of first pilot tones is 36; and/or
in a case where a size of at least one of the virtual RU, the virtual MRU, the logical RU or the logical MRU allocated to a single STA is 996 tones, the number of first data tones is 924, and the number of first pilot tones is 72; and/or
in a case where sizes of RUs of at least one of the virtual RU, the virtual MRU, the logical RU or the logical MRU allocated to a single STA are 484 tones and 242 tones respectively, the number of first data tones is 672, and the number of first pilot tones is 54.
where the at least one of the virtual RU, the virtual MRU, the logical RU or the logical MRU allocated to the single STA is indicated by the RU allocation information.

It can be seen from table 3 and table 4 that, in case one, compared with the physical RU/MRU, the virtual RU/MRU with the same size may have a smaller number of data tones. It can be seen from data of the last columns of table 3 and table 4 that, the reduction rates a of data tones are both less than the threshold ϕ (such as ϕ=10%) in the rule (6) of the above interleaving rules, so the RU interleaving mode is used in the cases shown in table 3 and table 4.

### Case Two:

the virtual RU/MRU (or the logical RU/MRU) has a different number of data tones and pilot tones than the physical RU/MRU with the same size. That is, the number of data virtual tones or data logical tones contained in at least one of the virtual RU, the virtual MRU, the logical RU or the logical MRU is the same as the number of data tones contained in the physical RU/MRU with the same size as the at least one of the virtual RU, the virtual MRU, the logical RU or the logical MRU; and/or
the number of pilot virtual tones or pilot logical tones contained in at least one of the virtual RU, the virtual MRU, the logical RU or the logical MRU is the same as the number of pilot tones contained in the physical RU/MRU with the same size as the at least one of the virtual RU, the virtual MRU, the logical RU or the logical MRU.

In some implementations, positions of pilot physical tones of at least one of the virtual RU, the virtual MRU, the logical RU or the logical MRU are independent of positions of pilot physical tones of respective reference RUs participating in the RU interleaving and positions of pilot physical tones of RUs not participating in the RU interleaving. Positions of pilot physical tones of the virtual RU/MRU are determined according to a pre-specified rule.

For example, positions of pilot virtual tones or pilot logical tones of at least one of the virtual RU, the virtual MRU, the logical RU or the logical MRU are the same as positions of pilot physical tones of the physical RU/MRU with the same size as the at least one of the virtual RU, the virtual MRU, the logical RU or the logical MRU. Positions of pilot physical tones of at least one of the virtual RU, the virtual MRU, the logical RU or the logical MRU are determined by positions of pilot virtual tones or pilot logical tones of the at least one of the virtual RU, the virtual MRU, the logical RU or the logical MRU, and an interleaving mode.

Taking the interleaving example shown in FIG. 5 as an example, positions of pilot virtual tones or pilot logical tones of the virtual 242-tone RU (shaded parts of virtual RU positions in the figure) are the same as positions of pilot physical tones of the corresponding physical 242-tone RU, i.e., {−246, −220, −178, −152, −112, −86, −44, −18}. According to the RU interleaving mode, the positions of the pilot physical tones correspond to the positions of these pilot virtual tones of {−439, −413, −178, −152, 73, 99, 334, 360}.

For example, when the interleaving granularity of 26-tone RU or 52-tone RU is selected to construct the virtual 242-tone RU, since the number of the pilot physical tones of the physical 242-tone RU with the same size is 8, the virtual 242-tone RU also includes 8 pilot virtual tones/pilot logical tones and 234 data virtual tones/data logical tones.

In this mode, the number of data virtual tones/data logical tones and the number of pilot virtual tones/pilot logical tones of the virtual RU/MRU constructed via the RU interleaving are equal to the number of data tones and the number of pilot tones of the corresponding physical RU/MRU, respectively; however, since a role of a pilot signal is to make coherent detection robust to frequency bias and phase noise, this mode may result in a degradation of performance of the pilot signal.

For the above case one, a structure of the virtual RU/MRU (or logical RU/MRU) may result in reduction in the number of data tones, thus leading to a change in relevant module parameters of the data field in the EHT PHY, specially as shown in table 5.

TABLE 5
Effect of the RU interleaving mode on EHT PHY parameters

| EHT PHY Module | | Cause parameter leading to the change |
|---|---|---|
| Data field | EHT PPDU padding | N_{SD, short} |
| | BCC interleaver | N_{COL} and N_{ROW} |
| | LDPC tone mapper | D_{TM} |

Herein, N_{SD,short} represents a number of data tones used when calculating a padding factor in EHT PPDU padding specified in the related art; N_{COL} represents a column parameter of a BCC interleaver specified in the related art, N_{ROW} represents a row parameter of the BCC interleaver specified in the related art; and D_{TM} represents a mapping distance parameter of low density parity check (LDPC) tone mapper specified in the related art. In order to ensure compatibility of the RU interleaving with the EHT PHY, in the embodiments of the present disclosure, for calculating parameter of padding factor of an EHT PPDU padding module, the interleaver parameter (including the column parameter and the row parameter) of the BCC interleaver module, and the mapping distance parameter of the LDPC tone mapper module, corresponding parameters after the RU interleaving are added.

In some implementations, the interleaving method proposed in the embodiments of the present disclosure further includes: determining, by the first device, according to the number of first data tones, at least one of a parameter used when the EHT PPDU padding module calculates a padding factor, an interleaver parameter of a BCC interleaver module, or a mapping distance parameter of an LDPC tone mapper module.

The following introduces determination methods for the above three types of parameters in the embodiments of the present disclosure, respectively.

A first type: EHT PPDU padding parameter.

The EHT PPDU padding is mainly divided into pre-forward error correction (pre-FEC) padding and post-forward error correction (post-FEC) padding. For the pre-FEC padding, 4 pre-FEC padding boundaries divide a last OFDM symbol of the EHT PPDU into 4 symbol segments, the 4 pre-FEC padding boundaries are represented by a pre-FEC padding factor parameter a, and the padding factor a is calculated according N_{SD,short}. Since the introduction of the RU interleaving causes a change of the number of data tones, thus it is necessary to add a parameter N_{SD,short}^{v} after the RU interleaving.

In some implementations, determining, by the first device, according to the number of first data tones, the parameter used when the EHT PPDU padding module calculates the padding factor, includes:
determining, by the first device, a number of second data tones according to the number of first data tones and a second rule; where the number of second data tones is the parameter used when the EHT PPDU padding module calculates the padding factor (such as the number of the data tones);
the second rule includes at least one of:
in a case where a modulation and coding scheme (MCS) index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, where the Nₛₛ represents a number of spatial streams, the N_{BPSCS} represents a number of coded bits per tone per spatial stream, and the R represents a coding rate.

For example, the above second rule (N_{SD,short}^{v} parameter adding rule) includes at least one of:
(a) when MCS∈[0,13], N_{SD,short}^{v} being an integer close to N_{SD}^{v}/4; and when MCS=15, N_{SD,short}^{v} being an integer close to N_{SD}^{v}/8, where [0, 13] represents a range from 0 to 13, i.e., including 0, 1, 2, 3, 4, 5, 6, 7, 8, 9, 10, 11, 12, and 13.
(b) when N_{SD,short}^{v} being an integer is satisfied, an expression of N_{DBPS,short}^{v} is shown in formula (1).

$${N}_{DBPS , short}^{v} = {N}_{SD , short}^{v} \cdot {N}_{ss} \cdot {N}_{BPSCS} \cdot R \qquad ( 1 )$$

where Nₛₛ represents the number of spatial streams; N_{DBPS,short}^{v} represents the number of data bits per OFDM symbol after the RU interleaving; N_{BPSCS} represents the number of coded bits per tone per spatial stream; and R represents a coding rate.

For the above rule (b), according to the MCS method specified in the related art, a value of N_{BPSCS}·R is shown in table 6. It can be seen that, without considering Nₛₛ, when MCS∈[0, 13], the value of N_{BPSCS}·R has a fraction with a denominator of 2 or 3, and therefore, N_{SD,short}^{v} must be an integer multiple of 6 (satisfying an integer multiple of 2 and an integer multiple of 3 at the same time), to satisfy that N_{SD,short}^{v} is an integer (i.e., a calculated result of N_{SD,short}^{v}·Nₛₛ·N_{BPSCS}·R is an integer). Similarly, when MCS=15, N_{SD,short}^{v} must be an integer multiple of 2, to satisfy that N_{SD,short}^{v} is an integer.

TABLE 6
values of N_{BPSCS} · R with different MCSs

| EHT-MCS index | Modulation | R | N_{BPSCS} | N_{BPSCS} · R |
|---|---|---|---|---|
| 0 | BPSK | 1/2 | 1 | 1/2 |
| 1 | QPSK | 1/2 | 2 | 1 |
| 2 | | 3/4 | | 3/2 |
| 3 | 16-QAM | 1/2 | 4 | 2 |
| 4 | | 3/4 | | 3 |
| 5 | 64-QAM | 2/3 | 6 | 4 |
| 6 | | 3/4 | | 9/2 |
| 7 | | 5/6 | | 5 |
| 8 | 256-QAM | 3/4 | 8 | 6 |
| 9 | | 5/6 | | 20/3 |
| 10 | 1024-QAM | 3/4 | 10 | 15/2 |
| 11 | | 5/6 | | 25/3 |
| 12 | 4096-QAM | 3/4 | 12 | 9 |
| 13 | | 5/6 | | 10 |
| 15 | BPSK-DCM | 1/2 | 1 | 1/2 |

In some implementations, determining, by the first device, a number of second data tones (i.e., a parameter used when the EHT PPDU padding module calculates the padding factor), includes:
in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones being 60; and/or
in a case where a size of at least one of a virtual RU, a virtual MRU, a logical RU or a logical MRU allocated to a single STA is 242 tones and the MCS index is 15, the number of second data tones being 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones being 114; and/or
in a case where a size of at least one of a virtual RU, a virtual MRU, a logical RU or a logical MRU allocated to a single STA is 484 tones and the MCS index is 15, the number of second data tones being 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones being 234; and/or
in a case where a size of at least one of a virtual RU, a virtual MRU, a logical RU or a logical MRU allocated to a single STA is 996 tones and the MCS index is 15, the number of second data tones being 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones being 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is being 84.

Table 7 shows an increased value of the EHT PPDU padding parameter N_{SD,short}^{v} according to a parameter adding principle, when the RU interleaving granularity is 26/52-tone.

TABLE 7
New added parameter N_{SD, short}^{v}, when the
RU interleaving granularity is 26/52-tone

N_{SD, short}^{v}

| RU/MRU (tone) | N_{SD}^{v} | MCS∈ [0, 13] | MCS = 15 |
|---|---|---|---|
| 242 | 224 | 60 | 28 |
| 484 | 448 | 114 | 56 |
| 484 + 242 | 672 | 168 | 84 |
| 996 | 924 | 234 | 116 |

Herein, a second column represents different values of N_{SD} (i.e., the number of pilot virtual tones or pilot logical tones contained in at least one of the virtual RU, the virtual MRU, the logical RU or the logical MRU) in a case of different sizes of the virtual RU/MRU (or the logical RU/MRU), and the values have been introduced in the above table 3 and table 4. A third column and a column represent specific values of N_{SD,short}^{v} determined according to the above second rule in a case of different values of N_{SD}^{v}. A case where the interleaving granularity is 26/52-tone, a size of the virtual RU/MRU (or the logical RU/MRU) is 484-tone, and MCS∈[0,13], is taken as an example, in this case, the value of N_{SD} is 448, in order to satisfy the rule (a) in the second rule, N_{SD,short}^{v} is an integer close to N_{SD}^{v}/4, that is, N_{SD,short}^{v} is an integer close to 448/4=112; in order to satisfy the rule (b) in the second rule, N_{SD,short}^{v} must be an integer multiple of 6. In order to satisfy both the rule (a) and the rule (b), the value of N_{SD,short}^{v} is determined to be 114. Determination methods of remaining data in table 7 all satisfy the above second rule and will not be introduced one by one here.

In the interleaving method proposed in the embodiments of the present disclosure, the parameter used when the EHT PPDU padding module calculates the padding factor, and which is determined by the first device according to the number of first data tones, may include N_{SD,short}^{v} in any one or more rows of data in table 7. And, the data in table 7 is for example only, other possible values of N_{SD,short}^{v} are not excluded in the embodiments of the present disclosure.

A second type: BCC interleaver parameter.

The BCC is applicable only to an RU or MRU with a size not exceeding 242-tone. BCC interleaver writes data in columns and reads data in rows, where a number of columns is N_{COL} and a number of rows is N_{ROW}.

Due to the change of the number of data tones N_{SD} after the RU interleaving, parameters N_{COL} and N_{ROW} of the BCC interleaver are caused to change. According to the using rule of the RU interleaving and in combination with the BCC using scenario, only the 242-tone RU affect the BCC interleaver parameters.

In some implementations, determining, by the first device, according to the number of first data tones, the interleaver parameter of the BCC interleaver module, includes:
determining, by the first device, a column parameter of the BCC interleaver module and a row parameter of the BCC interleaver module according to the number of first data tones and a third rule;
where the third rule includes: a product of the column parameter of the BCC interleaver module and the row parameter of the BCC interleaver module being equal to a product of the number of first data tones and N_{BPSCS}, where the N_{BPSCS} represents a number of coded bits per tone per spatial stream.

For example, in the embodiments of the present disclosure, parameters N_{COL}^{v} (the column parameter of the BCC interleaver module) and N_{ROW}^{v} (the row parameter of the BCC interleaver module) in the BCC interleaver after the RU interleaving are added, and the above third rule (N_{COL}^{v} and N_{ROW}^{v} parameter adding rule) includes: N_{COL}^{v}×N_{ROW}^{v}=N_{SD}^{v}×N_{BPSCS}, and N_{COL}^{v} and N_{ROW}^{r} being integers.

In some implementations, determining, by the first device, the column parameter of the BCC interleaver module and the row parameter of the BCC interleaver module according to the number of first data tones and the third rule, includes:
in a case where a size of at least one of a virtual RU, a virtual MRU, a logical RU or a logical MRU allocated to a single STA is 242 tones and dual carrier modulation (DCM) is not used, the column parameter of the BCC interleaver module is 28, and the row parameter of the BCC interleaver module is 8×N_{BPSCS}; and/or
in a case where a size of at least one of a virtual RU, a virtual MRU, a logical RU or a logical MRU allocated to a single STA is 242 tones and the DCM is used, the column parameter of the BCC interleaver module is 14, and the row parameter of the BCC interleaver module is 8×N_{BPSCS}.

Table 8 shows an increased value of the BCC interleaver parameter EHT PPDU padding parameter N_{SD,short}^{v} according to the parameter adding rule, when the RU interleaving granularity is 26/52-tone.

TABLE 8
Newly added parameters of the BCC interleaver, when
the RU interleaving granularity is 26/52-tone
Virtual 242-tone RU

RU interleaving granularity

| DCM | Parameter | 26-tone | 52-tone |
|---|---|---|---|
| Unused | N_{SD}^{v} | 224 | 224 |
| | N_{COL}^{v} | 28 | 28 |
| | N_{ROW}^{v} | 8 × N_{BPSCS} | 8 × N_{BPSCS} |
| used | N_{SD}^{v} | 112 | 112 |
| | N_{COL}^{v} | 14 | 14 |
| | N_{ROW}^{v} | 8 × N_{BPSCS} | 8 × N_{BPSCS} |

where N_{BPSCS} represents the number of coded bits per tone per spatial stream.

In the interleaving method proposed in the embodiments of the present disclosure, the added parameters of the BCC interleaver determined by the first device according to the number of first data tones may include any N_{COL}^{v} and N_{ROW}^{v} in table 8. And, the data in table 8 is for example only, other possible values of N_{COL}^{v} and N_{ROW}^{v} are not excluded in the embodiments of the present disclosure.

A third type: LDPC tone mapper parameter.

A data stream with LDPC coding is mapped according to a certain rule, and when the DCM is used, an LDPC tone mapping distance is D_{TM_DCM}; when the DCM is not used, the LDPC tone mapping distance is D_{TM}.

According to the using rule of the RU interleaving, LDPC tone mapper parameters of the virtual 242-tone, 484-tone, 484+242-tone, and 996-tone RUs need to be added.

In some implementations, determining, by the first device, according to the number of first data tones, the mapping distance parameter of the LDPC tone mapper module, includes:
determining, by the first device, the mapping distance parameter of the LDPC tone mapper module according to the number of first data tones and a fourth rule;
where the fourth rule includes at least one of:
the mapping distance parameter of the LDPC tone mapper module being greater than or equal to N_{CBPS}/L_{CW}, where the N_{CBPS} represents a number of coding bits per OFDM symbol, and the L_{CW} represents a length of an LDPC codeword;
in a case where DCM is not used, the mapping distance parameter of the LDPC tone mapper module being equal to N_{SD}^{v}/k; in a case where the DCM is used, the mapping distance parameter of the LDPC tone mapper module being equal to N_{SD}^{v}/2k, where N_{SD}^{v} represents the number of first data tones, and the k is an integer; or
the mapping distance parameter of the LDPC tone mapper module being constant for all MCS rates within each RU/MRU.

For example, the above fourth rule (D_{TM}^{v} parameter adding rule) includes at least one of:
(a) D_{TM}^{v} being at least equal to N_{CBPS}/L_{CW} to ensure that each LDPC codeword covers the entire tone range;
where N_{CBPS} represents the number of coded bits per OFDM symbol; L_{CW} represents the length of an LDPC codeword;
(b) D_{TM}^{v}=N_{SD}^{v}/k, where k is an integer (i.e., D_{TM} is an integer divisor of N_{SD}^{v}); and if the DCM is used, D_{TM_DCM}^{v}=N_{SD}^{v}/2k, k is an integer;
(c) the value of D_{TM}^{v} being constant for all MCS rates within each RU or MRU (i.e., D_{TM}^{v} depends only on the size of the RU or MRU and is independent of the MCS), so that a tone de-mapper processes the tones in a fixed manner in a Fast Fourier Transform (FFT) module at an Rx (Receiving) end.

When the RU interleaving granularity is 26/52-tone, according to the above fourth rule, and considering the compatibility with the EHT PHY, in the embodiments of the present disclosure, D_{TM}^{v} and D_{TM_DCM}^{v} in cases of a virtual/logical 242-tone RU, a virtual/logical 484-tone RU, a virtual/logical 484+242-tone MRU, and a virtual/logical 996-tone RU, being added, includes at least the following cases.

(1) Virtual/logical 242-tone RU.

N_{SD}^{v}=224, and according to rules (a), (b), and (c), the following may be obtained:
candidate values of D_{TM}^{v} of the virtual/logical 242-tone RU being 2, 4, 7, 8, 14, 16, 28, 32, 56, and 112; (such as in a case where the rule (b) is satisfied, the candidate values of D_{TM}^{v} of the 242-tone RU can be obtained by dividing N_{SD}^{v} of the virtual/logical 242-tone RU by a positive integer; as shown in the above table 3 and table 4, when the RU interleaving granularity is 26/52-tone, the N_{SD} of the virtual/logical 242-tone RU is 224; values obtained by dividing 224 by 2, 4, 7, 8, 14, 16, 28, 32, 56, and 112 are integers, and may be used as the above candidate values, respectively. The calculation method for subsequent candidate values is the same as that in this case, and will not be repeated hereafter);
candidate values of D_{TM_DCM}^{v} of the virtual/logical 242-tone RU being 2, 4, 7, 8, 14, 16, 28, and 56.

In order to reduce the complexity of the implementation, in the embodiments of the present disclosure, in combination with D_{TM}=9 and D_{TM_DCM}=9 of the physical 242-tone RU in the related art, it may be determined that when the RU interleaving granularity is 26/52-tone, the added LDPC tone mapper mapping distance parameters of the virtual/logical 242-tone RU, D_{TM}^{v}=8 and D_{TM_DCM}^{v}=8. That is, in the embodiments of the present disclosure, values close to D_{TM} and D_{TM_DCM} of the physical 242-tone RU with the same size in the related art are selected from the above candidate values, as values of D_{TM} and D_{TM_DCM} of the selected virtual/logical 242-tone RU.

(2) Virtual 484-tone RU.

N_{SD}^{v}=448, according to rules (a), (b), and (c), the following may be obtained:
candidate values of D_{TM}^{v} of the virtual 484-tone RU being 2, 4, 7, 8, 14, 16, 28, 32, 56, 64, 112, and 224;
candidate values of D_{TM_DCM}^{v} of the virtual 484-tone RU being 2, 4, 7, 8, 14, 16, 28, 32, 56, and 112.

In order to reduce the complexity of the implementation, in the embodiments of the present disclosure, in combination with D_{TM}=12 and D_{TM_DCM}=9 of the physical 484-tone RU in the related art, it may be determined that when the RU interleaving granularity is 26/52-tone, the added LDPC tone mapper mapping distance parameters of the virtual/logical 484-tone RU, D_{TM}^{v}=14 and D_{TM_DCM}^{v}=8. That is, in the embodiments of the present disclosure, values close to D_{TM} and D_{TM_DCM} of the physical 484-tone RU with the same size in the related art are selected from the above candidate values, as values of D_{TM} and D_{TM_DCM} of the selected virtual/logical 484-tone RU.

(3) Virtual 484+242-tone MRU.

N_{SD}^{v}=672, according to rules (a), (b), and (c), the following may be obtained:
candidate values of D_{TM}^{v} of the virtual 484+242-tone RU being 2, 3, 4, 6, 7, 8, 12, 14, 16, 21, 24, 28, 32, 42, 48, 56, 84, 96, 112, 168, 224, and 336;
candidate values of D_{TM_DCM}^{v} of the virtual 484+242-tone RU being 2, 3, 4, 6, 7, 8, 12, 14, 16, 21, 24, 28, 42, 48, 56, 84, 112, and 168.

In order to reduce the complexity of the implementation, in the embodiments of the present disclosure, in combination with D_{TM}=18 and D_{TM_DCM}=9 of the physical 484+242-tone RU in the related art, it may be determined that when the RU interleaving granularity is 26/52-tone, the added LDPC tone mapper mapping distance parameters of the logical/virtual 484+242-tone RU, D_{TM}^{v}=16 and D_{TM_DCM}^{v}=8. That is, in the embodiments of the present disclosure, values close to D_{TM} and D_{TM_DCM} of the physical 484+242-tone RU with the same size in the related art are selected from the above candidate values, as values of D_{TM} and D_{TM_DCM} of the selected virtual/logical 484+242-tone RU.

(4) Virtual 996-tone RU.

N_{SD}^{v}=924, according to rules (a), (b), and (c), the following may be obtained:
candidate values of D_{TM} of the virtual 996-tone RU being 2, 3, 4, 6, 7, 11, 12, 14, 21, 22, 28, 33, 42, 44, 66, 77, 84, 132, 154, 231, 308, and 462;
candidate values of D_{TM_DCM}^{v} of the virtual 996-tone RU being 2, 3, 6, 7, 11, 14, 21, 22, 33, 42, 66, 77, 154, and 231.

In order to reduce the complexity of the implementation, in the embodiments of the present disclosure, in combination with D_{TM}=20 and D_{TM_DCM}=14 of the physical 996-tone RU in the related art, it may be determined that when the RU interleaving granularity is 26/52-tone, the added LDPC tone mapper mapping distance parameters of the virtual 996-tone RU, D_{TM}^{v}=21 and D_{TM_DCM}^{v}=14. That is, in the embodiments of the present disclosure, values close to D_{TM} and D_{TM_DCM} of the physical 996-tone RU with the same size in the related art are selected from the above candidate values, as values of D_{TM} and D_{TM_DCM} of the selected virtual/logical 996-tone RU.

In some implementations, in a case where a size of at least one of a virtual RU, a virtual MRU, a logical RU, or a logical MRU allocated to a single STA is 242 tones and the DCM is not used, the mapping distance parameter of the LDPC tone mapper module is 8; and/or
in a case where a size of at least one of a virtual RU, a virtual MRU, a logical RU, or a logical MRU allocated to a single STA is 242 tones and the DCM is used, the mapping distance parameter of the LDPC tone mapper module is 8; and/or
in a case where a size of at least one of a virtual RU, a virtual MRU, a logical RU, or a logical MRU allocated to a single STA is 484 tones and the DCM is not used, the mapping distance parameter of the LDPC tone mapper module is 14; and/or
in a case where a size of at least one of a virtual RU, a virtual MRU, a logical RU, or a logical MRU allocated to a single STA is 484 tones and the DCM is used, the mapping distance parameter of the LDPC tone mapper module is 8; and/or
in a case where a size of at least one of a virtual RU, a virtual MRU, a logical RU, or a logical MRU allocated to a single STA is 996 tones and the DCM is not used, the mapping distance parameter of the LDPC tone mapper module is 21; and/or
in a case where a size of at least one of a virtual RU, a virtual MRU, a logical RU, or a logical MRU allocated to a single STA is 996 tones and the DCM is used, the mapping distance parameter of the LDPC tone mapper module is 14; and/or
in a case where sizes of RUs in at least one of a virtual RU, a virtual MRU, a logical RU, or a logical MRU allocated to a single STA are 484 tones and 242 tones respectively, and the DCM is not used, the mapping distance parameter of the LDPC tone mapper module is 16; and/or
in a case where sizes of RUs in at least one of a virtual RU, a virtual MRU, a logical RU, or a logical MRU allocated to a single STA are 484 tones and 242 tones respectively, and the DCM is used, the mapping distance parameter of the LDPC tone mapper module is 8.

Combining the above content, when the RU interleaving granularity is 26/52-tone, the added LDPC tone mapper mapping distance parameters of the virtual RUs/MRUs with different sizes are shown in table 9:

TABLE 9

Size (tone) of the Virtual RU/MRU

| Parameter | 242 | 484 | 484 + 242 | 996 |
|---|---|---|---|---|
| D_{TM}^{v} | 8 | 14 | 16 | 21 |
| D_{TM}_{_{—}}_{DCM}^{v} | 8 | 8 | 8 | 14 |

In the interleaving method proposed in the embodiments of the present disclosure, the LDPC tone mapper mapping distance parameter determined by the first device according to the number of first data tones may include D_{TM}^{v} and D_{TM_DCM}^{v} in any one or more columns of data in table 9. And, the data in table 9 is for example only, other possible values of D_{TM}^{v} and D_{TM_DCM}^{v} are not excluded in the embodiments of the present disclosure.

According to the above added parameters, the first device in the embodiments of the present disclosure may perform relevant processing on data to be transmitted.

The effect of the RU interleaving mode proposed in the embodiments of the present disclosure on the respective module parameters is not limited to only the parameters mentioned in the above table 7 to table 9, all parameters related to the number of data tones may also be affected, and these parameters may also have other adding methods and added values, which will not be exhausted in the embodiments of the present disclosure.

In some implementations, the interleaving method proposed in the embodiments of the present disclosure may further include: transmitting, by the first device, an OFDMA EHT PPDU on interleaved RU, where the OFDMA EHT PPDU carries the first information.

It can be seen that the embodiments of the present disclosure propose the RU interleaving scheme used by the OFDMA EHT PPDU, for the scenario of large-bandwidth OFDMA EHT PPDU transmission involving a plurality of STAs, and a higher frequency diversity gain may be obtained after the RUs or MRUs allocated to the STAs are interleaved and mapped. The embodiments of the present disclosure propose the using rules of the RU interleaving, which specify the bandwidth, the RU interleaving granularity, upper and lower limits of the size of the RU to be interleaved, etc., thereby improving the using scenario of the RU interleaving scheme. And, in the embodiments of the present disclosure, the reduction rate of the data tones is determined by considering the effect of the RU interleaving on the EHT PHY module, and the EHT PPDU padding parameter, the BCC interleaver parameter, and the LDPC tone mapper parameter are added correspondingly.

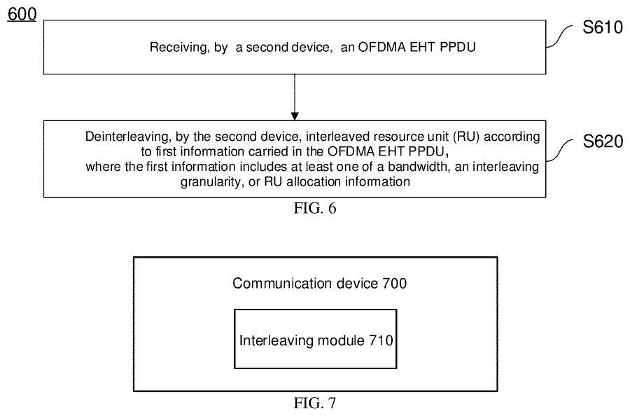

The embodiments of the present disclosure further propose a deinterleaving method. FIG. 6 is a schematic flow chart of a deinterleaving method 600 according to an embodiment of the present disclosure. The method may optionally be applied to the system shown in FIG. 1, but not limited thereto. The method includes at least some of the following contents:
S610: receiving, by a second device, an OFDMA EHT PPDU;
S620: deinterleaving, by the second device, an interleaved resource unit (RU) according to first information carried in the OFDMA EHT PPDU, where the first information includes at least one of a bandwidth, an interleaving granularity or RU allocation information.

The above second device is a receiving end for the OFDMA EHT PPDU, and in some implementations, the above second device is an AP or an STA.

In some implementations, the deinterleaving method proposed in the embodiments of the present disclosure may further include:
determining, by the second device, a number of first data tones and/or a number of first pilot tones according to the first information;
where the number of first data tones is a number of data virtual tones or data logical tones contained in at least one of a virtual RU, a virtual MRU, a logical RU, or a logical MRU; or
the number of first pilot tones is a number of pilot virtual tones or pilot logical tones contained in at least one of a virtual RU, a virtual MRU, a logical RU, or a logical MRU.

In some implementations, in a case where a size of at least one of a virtual RU, a virtual MRU, a logical RU or a logical MRU allocated to a single STA is 242 tones, the number of first data tones is 224, and the number of first pilot tones is 18; and/or
in a case where a size of at least one of a virtual RU, a virtual MRU, a logical RU or a logical MRU allocated to a single STA is 484 tones, the number of first data tones is 448, and the number of first pilot tones is 36; and/or
in a case where a size of at least one of a virtual RU, a virtual MRU, a logical RU or a logical MRU allocated to a single STA is 996 tones, the number of first data tones is 924, and the number of first pilot tones is 72; and/or
in a case where sizes of RUs of at least one of a virtual RU, a virtual MRU, a logical RU or a logical MRU allocated to a single STA are 484 tones and 242 tones respectively, the number of first data tones is 672, and the number of first pilot tones is 54;
where the at least one of the virtual RU, the virtual MRU, the logical RU or the logical MRU allocated to the single STA is indicated by the RU allocation information.

In some implementations, the deinterleaving method proposed in the embodiments of the present disclosure may further include:
determining, by the second device, according to the number of first data tones, at least one of a parameter used when an EHT PPDU padding module calculates a padding factor, an interleaver parameter of a BCC interleaver module, or a mapping distance parameter of an LDPC tone mapper module.

In some implementations, determining, by the second device, according to the number of first data tones, the parameter used when the EHT PPDU padding module calculates the padding factor, includes:
determining, by the second device, a number of second data tones according to the number of first data tones and a second rule; where the number of second data tones is the parameter used when the EHT PPDU padding module calculates the padding factor;
the second rule includes at least one of:
in a case where an MCS index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, where the Nₛₛ represents a number of spatial streams, the N_{BPSCS} represents a number of coded bits per tone per spatial stream, and the R represents a coding rate.

In some implementations, in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones is 60; and/or
in a case where a size of at least one of a virtual RU, a virtual MRU, a logical RU or a logical MRU allocated to a single STA is 242 tones and the MCS index is 15, the number of second data tones is 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones is 114; and/or
in a case where a size of at least one of a virtual RU, a virtual MRU, a logical RU or a logical MRU allocated to a single STA is 484 tones and the MCS index is 15, the number of second data tones being 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones is 234; and/or
in a case where a size of at least one of a virtual RU, a virtual MRU, a logical RU or a logical MRU allocated to a single STA is 996 tones and the MCS index is 15, the number of second data tones is 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones is 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is 84.

In some implementations, determining, by the second device, according to the number of first data tones, the interleaver parameter of the BCC interleaver module, includes:
determining, by the second device, a column parameter of the BCC interleaver module and a row parameter of the BCC interleaver module according to the number of first data tones and a third rule;
where the third rule includes: a product of the column parameter of the BCC interleaver module and the row parameter of the BCC interleaver module being equal to a product of the number of first data tones and N_{BPSCS}, where the N_{BPSCS} represents a number of coded bits per tone per spatial stream.

In some implementations, in a case where a size of at least one of a virtual RU, a virtual MRU, a logical RU or a logical MRU allocated to a single STA is 242 tones and DCM is not used, the column parameter of the BCC interleaver module is 28, and the row parameter of the BCC interleaver module is 8×N_{BPSCS}; and/or
in a case where a size of at least one of a virtual RU, a virtual MRU, a logical RU or a logical MRU allocated to a single STA is 242 tones and the DCM is used, the column parameter of the BCC interleaver module is 14, and the row parameter of the BCC interleaver module is 8×N_{BPSCS}.

In some implementations, determining, by the second device, according to the number of first data tones, the mapping distance parameter of the LDPC tone mapper module, includes:
determining, by the first device, the mapping distance parameter of the LDPC tone mapper module according to the number of first data tones and a fourth rule;
where the fourth rule includes at least one of:
the mapping distance parameter of the LDPC tone mapper module being greater than or equal to N_{CBPS}/L_{CW}, where the N_{CBPS} represents a number of coding bits per OFDM symbol, and the L_{CW} represents a length of an LDPC codeword;
in a case where DCM is not used, the mapping distance parameter of the LDPC tone mapper module being equal to N_{SD}^{v}/k; in a case where the DCM is used, the mapping distance parameter of the LDPC tone mapper module being equal to N_{SD}^{v}/2k, where N_{SD}^{v} represents the number of first data tones, and the k is an integer; or
the mapping distance parameter of the LDPC tone mapper module being constant for all MCS rates within each RU/MRU.

In some implementations, in a case where a size of at least one of a virtual RU, a virtual MRU, a logical RU, or a logical MRU allocated to a single STA is 242 tones and the DCM is not used, the mapping distance parameter of the LDPC tone mapper module is 8; and/or
in a case where a size of at least one of a virtual RU, a virtual MRU, a logical RU, or a logical MRU allocated to a single STA is 242 tones and the DCM is used, the mapping distance parameter of the LDPC tone mapper module is 8; and/or
in a case where a size of at least one of a virtual RU, a virtual MRU, a logical RU, or a logical MRU allocated to a single STA is 484 tones and the DCM is not used, the mapping distance parameter of the LDPC tone mapper module is 14; and/or
in a case where a size of at least one of a virtual RU, a virtual MRU, a logical RU, or a logical MRU allocated to a single STA is 484 tones and the DCM is used, the mapping distance parameter of the LDPC tone mapper module is 8; and/or
in a case where a size of at least one of a virtual RU, a virtual MRU, a logical RU, or a logical MRU allocated to a single STA is 996 tones and the DCM is not used, the mapping distance parameter of the LDPC tone mapper module is 21; and/or
in a case where a size of at least one of a virtual RU, a virtual MRU, a logical RU, or a logical MRU allocated to a single STA is 996 tones and the DCM is used, the mapping distance parameter of the LDPC tone mapper module is 14; and/or
in a case where sizes of RUs in at least one of a virtual RU, a virtual MRU, a logical RU, or a logical MRU allocated to a single STA are 484 tones and 242 tones respectively, and the DCM is not used, the mapping distance parameter of the LDPC tone mapper module is 16; and/or
in a case where sizes of RUs in at least one of a virtual RU, a virtual MRU, a logical RU, or a logical MRU allocated to a single STA are 484 tones and 242 tones respectively, and the DCM is used, the mapping distance parameter of the LDPC tone mapper module is 8.

The method for the second device determining the number of first data tones (i.e., the number of data virtual tones or data logical tones contained in at least one of the virtual RU, the virtual MRU, the logical RU or the logical MRU), the parameter used when the EHT PPDU padding module calculates the padding factor, the interleaver parameter of the BCC interleaver module, and the mapping distance parameter of the LDPC tone mapper module may refer to the above method for the first device determining relevant parameters, which will not be repeated here. The second device may process and/or identify the received data according to the above-mentioned parameters.

FIG. 7 is a schematic block diagram of a communication device 700 according to an embodiment of the present disclosure. The communication device 700 may include:
an interleaving module 710, configured to interleave a resource unit (RU) according to first information, where the first information includes at least one of a bandwidth, an interleaving granularity or RU allocation information.

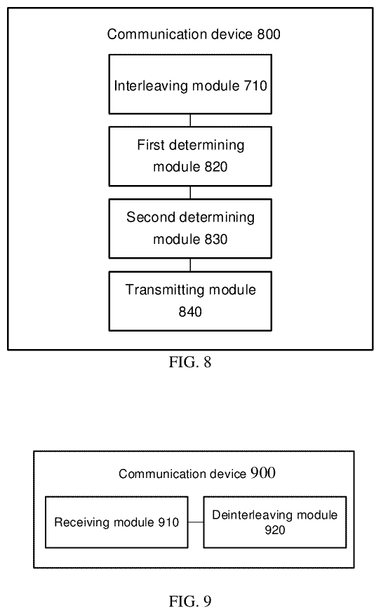

The embodiments of the present disclosure further propose another communication device, and FIG. 8 is a structural schematic diagram of a communication device 800 according to an embodiment of the present disclosure, including:
an interleaving module 710, a first determining module 820, a second determining module 830 and a transmitting module 840, where the interleaving module 710 is the same as the above corresponding module and will not be repeated here.

In some implementations, in a case where the interleaving granularity is 26 tones, the interleaving module 710 is configured to:
divide the bandwidth into a plurality of first physical RUs according to the interleaving granularity, where a size of the first physical RU is the same as a size of the interleaving granularity;
interleave the plurality of first physical RUs according to a rule of an interleaver;
map interleaved respective first physical RUs to corresponding first virtual RUs respectively, where the respective first virtual RUs form at least one of a virtual RU, a virtual MRU, a logical RU or a logical MRU, in sequence.

In some implementations, the above interleaving module 710 is configured to: in a case where the bandwidth is 80 MHz, divide the bandwidth into 36 first physical RUs; or
in a case where the bandwidth is 160 MHz, divide the bandwidth into 72 first physical RUs; or
in a case where the bandwidth is 320 MHz, divide the bandwidth into 144 first physical RUs.

In some implementations, in a case where the interleaving granularity is 52 tones, the interleaving module 710 is configured to:
divide the bandwidth into a plurality of first physical RUs and at least one second physical RU according to the interleaving granularity, where a size of the first physical RU is the same as a size of the interleaving granularity, and a size of the second physical RU is 26 tones;
interleave the plurality of first physical RUs according to a rule of an interleaver; and
map interleaved respective of first physical RUs to corresponding first virtual RUs respectively, and map the respective second physical RUs to corresponding second virtual RUs respectively, where the respective first virtual RUs and the second virtual RUs form at least one of a virtual RU, a virtual MRU, a logical RU or a logical MRU, in sequence.

In some implementations, the interleaving module 710 is configured to: in a case where the bandwidth is 80 MHz, divide the bandwidth into 16 first physical RUs and 4 second physical RUs; or,
in a case where the bandwidth is 160 MHz, divide the bandwidth into 32 first physical RUs and 8 second physical RUs; or,
in a case where the bandwidth is 320 MHz, divide the bandwidth into 64 first physical RUs and 16 second physical RUs.

In some implementations, the above interleaver includes at least one of a block interleaver, a triangular interleaver, a spiral interleaver or a ladder interleaver.

In some implementations, the interleaving module 710 is configured to: interleave the RU according to the first information in a case where a first rule is satisfied; where the first rule includes at least one of:
the interleaving granularity being 26 tones or 52 tones;
the bandwidth being greater than or equal to a preset bandwidth threshold;
at least one of a virtual RU, a virtual MRU, a logical RU or a logical MRU allocated to a single STA being a large-size RU/MRU;
a size of at least one of a virtual RU, a virtual MRU, a logical RU or a logical MRU allocated to a single STA being greater than or equal to M interleaving granularities, where the M is a positive integer;
a size of at least one of a virtual RU, a virtual MRU, a logical RU or a logical MRU allocated to a single STA being less than or equal to 1/N of a size of a bandwidth RU corresponding to the bandwidth, where the N is a positive integer;
a reduction rate of a number of data virtual tones or data logical tones included in at least one of a virtual RU, a virtual MRU, a logical RU or a logical MRU to a number of data tones included in a physical RU/MRU with a same size as the at least one of the virtual RU, the virtual MRU, the logical RU or the logical MRU, being less than or equal to a preset value; or
performing OFDMA transmission;
where the at least one of the virtual RU, the virtual MRU, the logical RU or the logical MRU allocated to the single STA is indicated by the RU allocation information.

In some implementations, the above preset bandwidth threshold is 40 MHz; and/or
the large-size RU is an RU including 242 tones, 484 tones, 996 tones or 2×996 tones; and/or
the large-size MRU includes at least two large-size RUs; and/or
the M is 2 or 3; and/or
the N is 4; and/or
the preset value is 10%.

In some implementations, a number of data virtual tones or data logical tones included in the at least one of the above-mentioned virtual RU, the virtual MRU, the logical RU or the logical MRU is different from a number of data tones included in a physical RU/MRU with a same size as the at least one of the second virtual RU, the first virtual MRU, the first logical RU or the first logical MRU; and/or
a number of pilot virtual tones or pilot logical tones included in the at least one of the virtual RU, the virtual MRU, the logical RU or the logical MRU is different from a number of pilot tones included in a physical RU/MRU with a same size as the at least one of the second virtual RU, the first virtual MRU, the first logical RU or the first logical MRU.

In some implementations, positions of pilot physical tones of the at least one of the virtual RU, the virtual MRU, the logical RU or the logical MRU are the same as positions of pilot physical tones of the plurality of first physical RUs; and/or
positions of pilot physical tones of the at least one of the virtual RU, the virtual MRU, the logical RU or the logical MRU are the same as positions of pilot physical tones of the plurality of first physical RUs and at least one second physical RU.

In some implementations, the above first determining module 820 is configured to: determine a number of first data tones and/or a number of first pilot tones according to the first information;
where the number of first data tones is the number of the data virtual tones or the data logical tones included in the at least one of the virtual RU, the virtual MRU, the logical RU or the logical MRU; or
the number of first pilot tones is the number of the pilot virtual tones or the pilot logical tones included in the at least one of the virtual RU, the virtual MRU, the logical RU or the logical MRU.

In some implementations, in a case where a size of at least one of a virtual RU, a virtual MRU, a logical RU or a logical MRU allocated to a single STA is 242 tones, the number of first data tones is 224, and the number of first pilot tones is 18; and/or
in a case where a size of at least one of a virtual RU, a virtual MRU, a logical RU or a logical MRU allocated to a single STA is 484 tones, the number of first data tones is 448, and the number of first pilot tones is 36; and/or
in a case where a size of at least one of a virtual RU, a virtual MRU, a logical RU or a logical MRU allocated to a single STA is 996 tones, the number of first data tones is 924, and the number of first pilot tones is 72; and/or,
in a case where sizes of RUs of at least one of a virtual RU, a virtual MRU, a logical RU or a logical MRU allocated to a single STA are 484 tones and 242 tones respectively, the number of first data tones is 672, and the number of first pilot tones is 54;
where the at least one of the virtual RU, the virtual MRU, the logical RU or the logical MRU allocated to the single STA is indicated by the RU allocation information.

In some implementations, the above second determining module 830 is configured to: determine, according to the number of first data tones, at least one of a parameter used when an EHT PPDU padding module calculates a padding factor, an interleaver parameter of a BCC interleaver module, or a mapping distance parameter of an LDPC tone mapper module.

In some implementations, the above second determining module 830 is configured to: determine a number of second data tones according to the number of first data tones and a second rule; where the number of second data tones is the parameter used when the EHT PPDU padding module calculates the padding factor;
the second rule includes at least one of:
in a case where an MCS index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, where the Nₛₛ represents a number of spatial streams, the N_{BPSCS} represents a number of coded bits per tone per spatial stream, and the R represents a coding rate.

In some implementations, in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones is 60; and/or
in a case where a size of at least one of a virtual RU, a virtual MRU, a logical RU or a logical MRU allocated to a single STA is 242 tones and the MCS index is 15, the number of second data tones is 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones is 114; and/or
in a case where a size of at least one of a virtual RU, a virtual MRU, a logical RU or a logical MRU allocated to a single STA is 484 tones and the MCS index is 15, the number of second data tones is 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones is 234; and/or
in a case where a size of at least one of a virtual RU, a virtual MRU, a logical RU or a logical MRU allocated to a single STA is 996 tones and the MCS index is 15, the number of second data tones is 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones is 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is 84.

In some implementations, the above second determining module 830 is configured to: determine a column parameter of the BCC interleaver module and a row parameter of the BCC interleaver module according to the number of first data tones and a third rule;
where the third rule includes: a product of the column parameter of the BCC interleaver module and the row parameter of the BCC interleaver module being equal to a product of the number of first data tones and N_{BPSCS}, where the N_{BPSCS} represents a number of coded bits per tone per spatial stream.

In some implementations, in a case where a size of at least one of a virtual RU, a virtual MRU, a logical RU or a logical MRU allocated to a single STA is 242 tones and DCM is not used, the column parameter of the BCC interleaver module is 28, and the row parameter of the BCC interleaver module is 8×N_{BPSCS}; and/or
in a case where a size of at least one of a virtual RU, a virtual MRU, a logical RU or a logical MRU allocated to a single STA is 242 tones and the DCM is used, the column parameter of the BCC interleaver module is 14, and the row parameter of the BCC interleaver module is 8×N_{BPSCS}.

In some implementations, the above second determining module 830 is configured to: determine the mapping distance parameter of the LDPC tone mapper module according to the number of first data tones and a fourth rule;
where the fourth rule includes at least one of:
the mapping distance parameter of the LDPC tone mapper module being greater than or equal to N_{CBPS}/L_{CW}, where the N_{CBPS} represents a number of coding bits per OFDM symbol, and the L_{CW} represents a length of an LDPC codeword;
in a case where DCM is not used, the mapping distance parameter of the LDPC tone mapper module being equal to N_{SD}^{v}/k; in a case where the DCM is used, the mapping distance parameter of the LDPC tone mapper module being equal to N_{SD}^{v}/2k, where N_{SD}^{v} represents the number of first data tones, and the k is an integer; or
the mapping distance parameter of the LDPC tone mapper module being constant for all MCS rates within each RU/MRU.

In some implementations, in a case where a size of at least one of a virtual RU, a virtual MRU, a logical RU, or a logical MRU allocated to a single STA is 242 tones and the DCM is not used, the mapping distance parameter of the LDPC tone mapper module is 8; and/or
in a case where a size of at least one of a virtual RU, a virtual MRU, a logical RU, or a logical MRU allocated to a single STA is 242 tones and the DCM is used, the mapping distance parameter of the LDPC tone mapper module is 8; and/or
in a case where a size of at least one of a virtual RU, a virtual MRU, a logical RU, or a logical MRU allocated to a single STA is 484 tones and the DCM is not used, the mapping distance parameter of the LDPC tone mapper module is 14; and/or
in a case where a size of at least one of a virtual RU, a virtual MRU, a logical RU, or a logical MRU allocated to a single STA is 484 tones and the DCM is used, the mapping distance parameter of the LDPC tone mapper module is 8; and/or
in a case where a size of at least one of a virtual RU, a virtual MRU, a logical RU, or a logical MRU allocated to a single STA is 996 tones and the DCM is not used, the mapping distance parameter of the LDPC tone mapper module is 21; and/or
in a case where a size of at least one of a virtual RU, a virtual MRU, a logical RU, or a logical MRU allocated to a single STA is 996 tones and the DCM is used, the mapping distance parameter of the LDPC tone mapper module is 14; and/or
in a case where sizes of RUs in at least one of a virtual RU, a virtual MRU, a logical RU, or a logical MRU allocated to a single STA are 484 tones and 242 tones respectively, and the DCM is not used, the mapping distance parameter of the LDPC tone mapper module is 16; and/or
in a case where sizes of RUs in at least one of a virtual RU, a virtual MRU, a logical RU, or a logical MRU allocated to a single STA are 484 tones and 242 tones respectively, and the DCM is used, the mapping distance parameter of the LDPC tone mapper module is 8.

In some implementations, a number of data virtual tones or data logical tones included in the at least one of the virtual RU, the virtual MRU, the logical RU or the logical MRU is the same as a number of data tones included in a physical RU/MRU with a same size as the at least one of the second virtual RU, the first virtual MRU, the first logical RU or the first logical MRU; and/or
a number of pilot virtual tones or pilot logical tones included in the at least one of the virtual RU, the virtual MRU, the logical RU or the logical MRU is the same as a number of pilot tones included in a physical RU/MRU with a same size as the at least one of the second virtual RU, the first virtual MRU, the first logical RU or the first logical MRU.

In some implementations, positions of the pilot virtual tones or the pilot logical tones of the at least one of the virtual RU, the virtual MRU, the logical RU or the logical MRU are the same as positions of pilot physical tones of the physical RU/MRU with the same size as the at least one of the second virtual RU, the first virtual MRU, the first logical RU or the first logical MRU.

In some implementations, positions of pilot physical tones of at least one of the virtual RU, the virtual MRU, the logical RU or the logical MRU mentioned above are determined by positions of pilot virtual tones or pilot logical tones of the at least one of the virtual RU, the virtual MRU, the logical RU or the logical MRU, and an interleaving mode.

In some implementations, the above transmitting module 840 is configured to: transmit an OFDMA EHT PPDU on interleaved RU, where the OFDMA EHT PPDU carries the first information.

The communication device 700 and the communication device 800 in the embodiments of the present disclosure can implement the corresponding functions of the first device in the above-mentioned method embodiments. The processes, functions, implementations and beneficial effects corresponding to respective modules (sub-modules, units or components, etc.) in the communication device 700 and the communication device 800 may refer to the corresponding description in the above method embodiments, and will not be repeated here. It needs to be noted that, the functions described regarding the respective modules (sub-modules, units or components, etc.) in the terminal device 700 and the communication device 800 of the embodiments of the present disclosure may be implemented by different modules (sub-modules, units or components, etc.), or may also be implemented by a same module (sub-module, unit or component, etc.).

FIG. 9 is a schematic block diagram of a communication device 900 according to an embodiment of the present disclosure. The communication device 900 may include:
a receiving module 910, configured to receive an OFDMA EHT PPDU;
a deinterleaving module 920, configured to deinterleave an interleaved resource unit (RU) according to first information carried in the OFDMA EHT PPDU, where the first information includes at least one of a bandwidth, an interleaving granularity or RU allocation information.

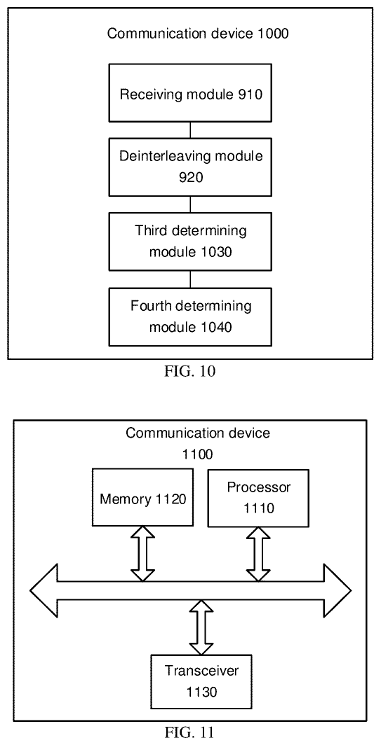

The embodiments of the present disclosure further propose another communication device, and FIG. 10 is a structural schematic diagram of a communication device 1000 according to an embodiment of the present disclosure, including:
a receiving module 910, a deinterleaving module 920, a third determining module 1030 and a fourth determining module 1040, where the receiving module 910 and the deinterleaving module 920 are the same as the above corresponding modules and will not be repeated here.

In some implementations, the above third determining module 1030 is configured to: determine a number of first data tones and/or a number of first pilot tones according to the first information;
where the number of first data tones is a number of data virtual tones or data logical tones included in at least one of a virtual RU, a virtual MRU, a logical RU or a logical MRU; or
the number of first pilot tones is a number of pilot virtual tones or pilot logical tones contained in at least one of a virtual RU, a virtual MRU, a logical RU or a logical MRU.

In some implementations, in a case where a size of at least one of a virtual RU, a virtual MRU, a logical RU or a logical MRU allocated to a single STA is 242 tones, the number of first data tones is 224, and the number of first pilot tones is 18; and/or
in a case where a size of at least one of a virtual RU, a virtual MRU, a logical RU or a logical MRU allocated to a single STA is 484 tones, the number of first data tones is 448, and the number of first pilot tones is 36; and/or
in a case where a size of at least one of a virtual RU, a virtual MRU, a logical RU or a logical MRU allocated to a single STA is 996 tones, the number of first data tones is 924, and the number of first pilot tones is 72; and/or
in a case where sizes of RUs of at least one of a virtual RU, a virtual MRU, a logical RU or a logical MRU allocated to a single STA are 484 tones and 242 tones respectively, the number of first data tones is 672, and the number of first pilot tones is 54;
where the at least one of the virtual RU, the virtual MRU, the logical RU or the logical MRU allocated to the single STA is indicated by the RU allocation information.

In some implementations, the above fourth determining module 1040 is configured to: determine, according to the number of first data tones, at least one of a parameter used when an EHT PPDU padding module calculates a padding factor, an interleaver parameter of a BCC interleaver module, or a mapping distance parameter of an LDPC tone mapper module.

In some implementations, the above fourth determining 1040 module is configured to: determine a number of second data tones according to the number of first data tones and a second rule; where the number of second data tones is the parameter used when the EHT PPDU padding module calculates the padding factor;
the second rule includes at least one of:
in a case where an MCS index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, where the Nₛₛ represents a number of spatial streams, the N_{BPSCS} represents a number of coded bits per tone per spatial stream, and the R represents a coding rate.

In some implementations, in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones is 60; and/or
in a case where a size of at least one of a virtual RU, a virtual MRU, a logical RU or a logical MRU allocated to a single STA is 242 tones and the MCS index is 15, the number of second data tones is 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones is 114; and/or
in a case where a size of at least one of a virtual RU, a virtual MRU, a logical RU or a logical MRU allocated to a single STA is 484 tones and the MCS index is 15, the number of second data tones is 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones is 234; and/or
in a case where a size of at least one of a virtual RU, a virtual MRU, a logical RU or a logical MRU allocated to a single STA is 996 tones and the MCS index is 15, the number of second data tones is 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones is 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is 84.

In some implementations, the above fourth determining 1040 module is configured to: determine a column parameter of the BCC interleaver module and a row parameter of the BCC interleaver module according to the number of first data tones and a third rule;
where the third rule includes: a product of the column parameter of the BCC interleaver module and the row parameter of the BCC interleaver module being equal to a product of the number of first data tones and N_{BPSCS}, where the N_{BPSCS} represents a number of coded bits per tone per spatial stream.

In some implementations, in a case where a size of at least one of a virtual RU, a virtual MRU, a logical RU or a logical MRU allocated to a single STA is 242 tones and a DCM is not used, the column parameter of the BCC interleaver module is 28, and the row parameter of the BCC interleaver module is 8×N_{BPSCS}; and/or
in a case where a size of at least one of a virtual RU, a virtual MRU, a logical RU or a logical MRU allocated to a single STA is 242 tones and the DCM is used, the column parameter of the BCC interleaver module is 14, and the row parameter of the BCC interleaver module is 8×N_{BPSCS}.

In some implementations, the above fourth determining module 1040 is configured to: determine the mapping distance parameter of the LDPC tone mapper module according to the number of first data tones and a fourth rule;
where the fourth rule includes at least one of:
the mapping distance parameter of the LDPC tone mapper module being greater than or equal to N_{CBPS}/L_{CW}, where the N_{CBPS} represents a number of coding bits per OFDM symbol, and the L_{CW} represents a length of an LDPC codeword;
in a case where DCM is not used, the mapping distance parameter of the LDPC tone mapper module being equal to N_{SD}^{v}/k; in a case where the DCM is used, the mapping distance parameter of the LDPC tone mapper module being equal to N_{SD}^{v}/2k, where N_{SD}^{v} represents the number of first data tones, and the k is an integer; or
the mapping distance parameter of the LDPC tone mapper module being constant for all MCS rates within each RU/MRU.

In some implementations, in a case where a size of at least one of a virtual RU, a virtual MRU, a logical RU, or a logical MRU allocated to a single STA is 242 tones and the DCM is not used, the mapping distance parameter of the LDPC tone mapper module is 8; and/or
in a case where a size of at least one of a virtual RU, a virtual MRU, a logical RU, or a logical MRU allocated to a single STA is 242 tones and the DCM is used, the mapping distance parameter of the LDPC tone mapper module is 8; and/or
in a case where a size of at least one of a virtual RU, a virtual MRU, a logical RU, or a logical MRU allocated to a single STA is 484 tones and the DCM is not used, the mapping distance parameter of the LDPC tone mapper module is 14; and/or
in a case where a size of at least one of a virtual RU, a virtual MRU, a logical RU, or a logical MRU allocated to a single STA is 484 tones and the DCM is used, the mapping distance parameter of the LDPC tone mapper module is 8; and/or
in a case where a size of at least one of a virtual RU, a virtual MRU, a logical RU, or a logical MRU allocated to a single STA is 996 tones and the DCM is not used, the mapping distance parameter of the LDPC tone mapper module is 21; and/or
in a case where a size of at least one of a virtual RU, a virtual MRU, a logical RU, or a logical MRU allocated to a single STA is 996 tones and the DCM is used, the mapping distance parameter of the LDPC tone mapper module is 14; and/or
in a case where sizes of RUs in at least one of a virtual RU, a virtual MRU, a logical RU, or a logical MRU allocated to a single STA are 484 tones and 242 tones respectively, and the DCM is not used, the mapping distance parameter of the LDPC tone mapper module is 16; and/or
in a case where sizes of RUs in at least one of a virtual RU, a virtual MRU, a logical RU, or a logical MRU allocated to a single STA are 484 tones and 242 tones respectively, and the DCM is used, the mapping distance parameter of the LDPC tone mapper module is 8.

The communication device 900 and the communication device 1000 in the embodiments of the present disclosure can implement the corresponding functions of the second device in the above-mentioned method embodiments. The processes, functions, implementations and beneficial effects corresponding to respective modules (sub-modules, units or components, etc.) in the communication device 900 and the communication device 1000 may refer to the corresponding description in the above method embodiments, and will not be repeated here. It needs to be noted that, the functions described regarding the respective modules (sub-modules, units or components, etc.) in the communication device 900 and the communication device 1000 of the embodiments of the present disclosure may be implemented by different modules (sub-modules, units or components, etc.), or may also be implemented by a same module (sub-module, unit or component, etc.).

FIG. 11 is a schematic structural diagram of a communication device 1100 according to the embodiments of the present disclosure. The communication device 1100 includes a processor 1110, and the processor 1110 may invoke and execute a computer program from a memory to cause the communication device 1100 to implement the method in the embodiments of the present disclosure.

Herein, a memory 1120 may be a separate device independent from the processor 1110, or may also be integrated into the processor 1110.

In a possible implementation, the communication device 1100 may further include a transceiver 1130, the processor 1110 may control the transceiver 1130 to communicate with other devices, and for example, to be capable of transmitting information or data to other devices, or receive information or data transmitted by other devices.

Herein, the transceiver 1130 may include a transmitter and a receiver. The transceiver 1130 may further include an antenna, and a number of antennas may be one or more.

In a possible implementation, the communication device 1100 may be the first device in the embodiments of the present disclosure, and the communication device 1100 may implement the corresponding processes implemented by the first device in respective methods of the embodiments of the present disclosure, which will not be repeated here for the sake of brevity.

In a possible implementation, the communication device 1100 may be the second device in the embodiments of the present disclosure, and the communication device 1100 may implement the corresponding processes implemented by the second device in respective methods of the embodiments of the present disclosure, which will not be repeated here for the sake of brevity.

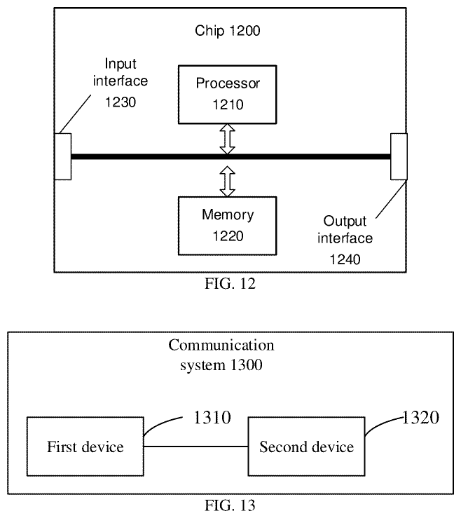

FIG. 12 is a schematic structural diagram of a chip 1200 according to the embodiments of the present disclosure. The chip 1200 includes a processor 1210, and the processor 1210 may invoke and execute a computer program from a memory to implement the method in the embodiments of the present disclosure.

In a possible implementation, the chip 1200 may further include a memory 1220. Herein, the processor 1210 may invoke and execute the computer program from the memory 1220 to implement the method performed by the first device or the second device in the embodiments of the present disclosure.

Herein, the memory 1220 may be a separate device independent from the processor 1210, or may also be integrated into the processor 1210.

In a possible implementation, the chip 1200 may further include an input interface 1230. Herein, the processor 1210 may control the input interface 1230 to communicate with other devices or chips, and for example, to be capable of acquiring information or data transmitted by other devices or chips.

In a possible implementation, the chip 1200 may further include an output interface 1240. Herein, the processor 1210 may control the output interface 1240 to communicate with other devices or chips, and for example, to be capable of outputting information or data to other devices or chips.

In a possible implementation, the chip may be applied to the first device in the embodiments of the present disclosure, and the chip may implement the corresponding processes implemented by a network device in the respective methods of the embodiments of the present disclosure, which will not be repeated here for the sake of brevity.

In a possible implementation, the chip may be applied to the second device in the embodiments of the present disclosure, and the chip may implement the corresponding processes implemented by a terminal device in the respective methods of the embodiments of the present disclosure, which will not be repeated here for the sake of brevity.

The chip applied to the first device and the second device may be a same chip or different chips.

It should be understood that, the chip mentioned in the embodiments of the present disclosure may also be referred to as a system on chip, a system chip, a chip system or a system-on-chip chip, etc.

The processor mentioned above may be a general-purpose processor, a digital signal processor (DSP), a field programmable gate array (FPGA), an application specific integrated circuit (ASIC) or other programmable logic devices, a transistor logic device, a discrete hardware component, etc. Herein, the general-purpose processor mentioned above may be a microprocessor or may also be any conventional processor.

The memory mentioned above may be a volatile memory or a non-volatile memory, or may include both volatile and non-volatile memories. Herein, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or a flash memory. The volatile memory may be a random access memory (RAM).

It should be understood that, the above memory is exemplary but not limiting illustration, e.g., the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present disclosure is intended to include, but not limited to, these and any other suitable types of memories.

FIG. 13 is a schematic block diagram of a communication system 1300 according to the embodiments of the present disclosure. The communication system 1300 includes a first device 1310 and a second device 1320. The first device 1310 interleaves a resource unit (RU) according to first information, where the first information includes at least one of a bandwidth, an interleaving granularity or RU allocation information; the second device receives an OFDMA EHT PPDU, and deinterleaves interleaved resource unit (RU) according to the first information carried in the OFDMA EHT PPDU, where the first information includes at least one of the bandwidth, the interleaving granularity, or the RU allocation information.

Herein, the first device 1310 may be configured to implement the corresponding functions implemented by the first device in the above method, and the second device 1320 may be configured to implement the corresponding functions implemented by the second device in the above method. For the sake of brevity, it will not repeated here.

The above embodiments may be implemented in whole or in part by software, hardware, firmware, or any combination thereof. When the above embodiments are implemented by using software, they may be implemented in a form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a non-transitory computer-readable storage medium or transmitted from one non-transitory computer-readable storage medium to another non-transitory computer-readable storage medium, for example, the computer instructions may be transmitted from a website site, computer, server, or data center to another website site, computer, server, or data center via wired (such as coaxial cable, fiber optic, digital subscriber line (DSL)) or wireless (such as infrared, radio, microwave, etc.) means. The non-transitory computer-readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)) or a semiconductor medium (e.g., a solid state disk (SSD)), etc.

It should be understood that, in the various embodiments of the present disclosure, a size of serial numbers of the above processes does not imply an order of execution, and the execution order of the respective processes should be determined by their function and internal logic, but should not constitute any limitation on the implementation processes of the embodiments of the present disclosure.

Those skilled in the art may clearly understand that, for the convenience and brevity of the description, the working processes of the systems, apparatus and units described above may refer to the corresponding processes in the above method embodiments, which will not be repeated here.

The above description is only the implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of claims.

What is claimed is:

1. An interleaving method, comprising:
interleaving, by a first device, a resource unit (RU) according to first information, wherein the first information comprises at least one of a bandwidth, an interleaving granularity or RU allocation information.

2. A communication device, comprising: a processor and a memory, wherein the memory is configured to store a computer program, and the processor is configured to invoke and execute the computer program stored in the memory, to cause the communication device to perform:
interleaving a resource unit (RU) according to first information, wherein the first information comprises at least one of a bandwidth, an interleaving granularity or RU allocation information.

3. The communication device according to claim 2, wherein in a case where the interleaving granularity is 26 tones, the processor is configured to invoke and execute the computer program, to cause the communication device to perform:
dividing the bandwidth into a plurality of first physical RUs according to the interleaving granularity, wherein a size of the first physical RU is the same as a size of the interleaving granularity;
interleaving the plurality of first physical RUs according to a rule of an interleaver;
mapping interleaved plurality of first physical RUs to corresponding first virtual RUs respectively, wherein a plurality of the first virtual RUs form at least one of a second virtual RU, a first virtual multiple resource unit (MRU), a first logical RU or a first logical MRU, in sequence.

4. The communication device according to claim 3, wherein the processor is configured to invoke and execute the computer program, to cause the communication device to perform:
in a case where the bandwidth is 80 MHz, dividing the bandwidth into 36 first physical RUs; or,
in a case where the bandwidth is 160 MHz, dividing the bandwidth into 72 first physical RUs; or,
in a case where the bandwidth is 320 MHz, dividing the bandwidth into 144 first physical RUs.

5. The communication device according to claim 2, wherein in a case where the interleaving granularity is 52 tones, the processor is configured to invoke and execute the computer program, to cause the communication device to perform:
dividing the bandwidth into a plurality of first physical RUs and at least one second physical RU according to the interleaving granularity, wherein a size of the first physical RU is the same as a size of the interleaving granularity, and a size of the second physical RU is 26 tones;
interleaving the plurality of first physical RUs according to a rule of an interleaver; and
mapping interleaved plurality of first physical RUs to corresponding first virtual RUs respectively, and mapping a plurality of second physical RUs to corresponding third virtual RUs respectively, wherein a plurality of the first virtual RUs and the third virtual RUs form at least one of a fourth virtual RU, a second virtual MRU, a second logical RU or a second logical MRU, in sequence.

6. The communication device according to claim 5, wherein the processor is configured to invoke and execute the computer program, to cause the communication device to perform:
in a case where the bandwidth is 80 MHz, dividing the bandwidth into 16 first physical RUs and 4 second physical RUs; or,
in a case where the bandwidth is 160 MHz, dividing the bandwidth into 32 first physical RUs and 8 second physical RUs; or,
in a case where the bandwidth is 320 MHz, dividing the bandwidth into 64 first physical RUs and 16 second physical RUs.

7. The communication device according to claim 3, wherein the interleaver comprises at least one of a block interleaver, a triangular interleaver, a spiral interleaver or a ladder interleaver.

8. The communication device according to claim 2, wherein interleaving the RU according to the first information, occurs in a case where a first rule is satisfied; the first rule comprises at least one of:
the interleaving granularity being 26 tones or 52 tones;
the bandwidth being greater than or equal to a preset bandwidth threshold;
at least one of a virtual RU, a virtual MRU, a logical RU or a logical MRU allocated to a single STA being a large-size RU/MRU;
a size of at least one of a virtual RU, a virtual MRU, a logical RU or a logical MRU allocated to a single STA being greater than or equal to M reference RUs, wherein the M is a positive integer, and the reference RU is a minimum interleaving unit;
a size of at least one of a virtual RU, a virtual MRU, a logical RU or a logical MRU allocated to a single STA being less than or equal to 1/N of a size of a bandwidth RU corresponding to the bandwidth, wherein the N is a positive integer;
a reduction rate of a number of data virtual tones or data logical tones comprised in at least one of a virtual RU, a virtual MRU, a logical RU or a logical MRU to a number of data tones comprised in a physical RU/MRU with a same size as the at least one of the virtual RU, the virtual MRU, the logical RU or the logical MRU, being less than or equal to a preset value; or
performing OFDMA transmission;
wherein the at least one of the virtual RU, the virtual MRU, the logical RU or the logical MRU allocated to the single STA is indicated by the RU allocation information.

9. The communication device according to claim 8, wherein
the preset bandwidth threshold is 40 MHz; and/or,
the large-size RU is an RU comprising 242 tones, 484 tones, 996 tones or 2×996 tones; and/or
the large-size MRU comprises at least two large-size RUs; and/or
the M is 2 or 3; and/or
the N is 4; and/or
the preset value is 10%.

10. The communication device according to claim 3, wherein
a number of data virtual tones or data logical tones comprised in the at least one of the second virtual RU, the first virtual MRU, the first logical RU or the first logical MRU is different from a number of data tones comprised in a physical RU/MRU with a same size as the at least one of the second virtual RU, the first virtual MRU, the first logical RU or the first logical MRU; and/or
a number of pilot virtual tones or pilot logical tones comprised in the at least one of the second virtual RU, the first virtual MRU, the first logical RU or the first logical MRU is different from a number of pilot tones comprised in a physical RU/MRU with a same size as the at least one of the second virtual RU, the first virtual MRU, the first logical RU or the first logical MRU.

11. The communication device according to claim 10, wherein
positions of pilot physical tones of the at least one of the second virtual RU, the first virtual MRU, the first logical RU or the first logical MRU are the same as positions of pilot physical tones of the plurality of first physical RUs; and/or
positions of pilot physical tones of the at least one of the second virtual RU, the first virtual MRU, the first logical RU or the first logical MRU are the same as positions of pilot physical tones of the plurality of first physical RUs and at least one second physical RU.

12. The communication device according to claim 10, the processor is configured to invoke and execute the computer program, to cause the communication device further to perform:
determining a number of first data tones and/or a number of first pilot tones according to the first information;
wherein the number of first data tones is equal to the number of the data virtual tones or the data logical tones comprised in the at least one of the second virtual RU, the first virtual MRU, the first logical RU or the first logical MRU; or
the number of first pilot tones is equal to the number of the pilot virtual tones or the pilot logical tones comprised in the at least one of the second virtual RU, the first virtual MRU, the first logical RU or the first logical MRU.

13. The communication device according to claim 5, wherein
a number of data virtual tones or data logical tones comprised in the at least one of the fourth virtual RU, the second virtual MRU, the second logical RU or the second logical MRU is different from a number of data tones comprised in a physical RU/MRU with a same size as the at least one of the fourth virtual RU, the second virtual MRU, the second logical RU or the second logical MRU; and/or
a number of pilot virtual tones or pilot logical tones comprised in the at least one of the fourth virtual RU, the second virtual MRU, the second logical RU or the second logical MRU is different from a number of pilot tones comprised in a physical RU/MRU with a same size as the at least one of the fourth virtual RU, the second virtual MRU, the second logical RU or the second logical MRU.

14. The communication device according to claim 13, wherein
positions of pilot physical tones of the at least one of the fourth virtual RU, the second virtual MRU, the second logical RU or the second logical MRU are the same as positions of pilot physical tones of the plurality of first physical RUs; and/or
positions of pilot physical tones of the at least one of the fourth virtual RU, the second virtual MRU, the second logical RU or the second logical MRU are the same as positions of pilot physical tones of the plurality of first physical RUs and the at least one second physical RU.

15. The communication device according to claim 13, the processor is configured to invoke and execute the computer program, to cause the communication device further to perform:
determining a number of first data tones and/or a number of first pilot tones according to the first information;
wherein the number of first data tones is equal to the number of data virtual tones or data logical tones comprised in the at least one of the fourth virtual RU, the second virtual MRU, the second logical RU or the second logical MRU; or
the number of first pilot tones is equal to the number of pilot virtual tones or pilot logical tones comprised in the at least one of the fourth virtual RU, the second virtual MRU, the second logical RU or the second logical MRU.

16. The communication device according to claim 12, wherein
in a case where a size of at least one of a virtual RU, a virtual MRU, a logical RU or a logical MRU allocated to a single STA is 242 tones, the number of first data tones is 224, and the number of first pilot tones is 18; and/or
in a case where a size of at least one of a virtual RU, a virtual MRU, a logical RU or a logical MRU allocated to a single STA is 484 tones, the number of first data tones is 448, and the number of first pilot tones is 36; and/or
in a case where a size of at least one of a virtual RU, a virtual MRU, a logical RU or a logical MRU allocated to a single STA is 996 tones, the number of first data tones is 924, and the number of first pilot tones is 72; and/or,
in a case where sizes of RUs of at least one of a virtual RU, a virtual MRU, a logical RU or a logical MRU allocated to a single STA are 484 tones and 242 tones respectively, the number of first data tones is 672, and the number of first pilot tones is 54;
wherein the at least one of the virtual RU, the virtual MRU, the logical RU or the logical MRU allocated to the single STA is indicated by the RU allocation information.

17. The communication device according to claim 12, the processor is configured to invoke and execute the computer program, to cause the communication device further to perform:
determining according to the number of first data tones, at least one of a parameter used when an extremely high throughput (EHT) physical layer protocol data unit (PPDU) padding module calculates a padding factor, an interleaver parameter of a binary convolutional code (BCC) interleaver module, or a mapping distance parameter of a low density parity check (LDPC) tone mapper module.

18. The communication device according to claim 17, wherein the processor is configured to invoke and execute the computer program, to cause the communication device to perform:
determining a number of second data tones according to the number of first data tones and a second rule; wherein the number of second data tones is the parameter used when the EHT PPDU padding module calculates the padding factor;
the second rule comprises at least one of:
in a case where a modulation and coding scheme (MCS) index is 0, 1, 2, 3, 4, 5, 6, 7, 8, 9, 10, 11, 12 or 13, the number of second data tones being an integer close to ¼ of the number of first data tones; or
in a case where the MCS index is 15, the number of second data tones being an integer close to ⅛ of the number of first data tones;
a product of the number of second data tones, Nₛₛ, N_{BPSCS} and R being an integer, wherein the Nₛₛ represents a number of spatial streams, the N_{BPSCS} represents a number of coded bits per tone per spatial stream, and the R represents a coding rate.

19. The communication device according to claim 18, wherein
in a case where a size of at least one of a virtual RU, a virtual MRU, a logical RU or a logical MRU allocated to a single STA is 242 tones and the MCS index is 0, 1, 2, 3, 4, 5, 6, 7, 8, 9, 10, 11, 12 or 13, the number of second data tones is 60; and/or
in a case where a size of at least one of a virtual RU, a virtual MRU, a logical RU or a logical MRU allocated to a single STA is 242 tones and the MCS index is 15, the number of second data tones is 28; and/or
in a case where a size of at least one of a virtual RU, a virtual MRU, a logical RU or a logical MRU allocated to a single STA is 484 tones and the MCS index is 0, 1, 2, 3, 4, 5, 6, 7, 8, 9, 10, 11, 12 or 13, the number of second data tones is 114; and/or
in a case where a size of at least one of a virtual RU, a virtual MRU, a logical RU or a logical MRU allocated to a single STA is 484 tones and the MCS index is 15, the number of second data tones being 56; and/or
in a case where a size of at least one of a virtual RU, a virtual MRU, a logical RU or a logical MRU allocated to a single STA is 996 tones and the MCS index is 0, 1, 2, 3, 4, 5, 6, 7, 8, 9, 10, 11, 12 or 13, the number of second data tones is 234; and/or
in a case where a size of at least one of a virtual RU, a virtual MRU, a logical RU or a logical MRU allocated to a single STA is 996 tones and the MCS index is 15, the number of second data tones is 116; and/or
in a case where sizes of RUs in at least one of a virtual RU, a virtual MRU, a logical RU or a logical MRU allocated to a single STA are 484 tones and 242 tones respectively, and the MCS index is 0, 1, 2, 3, 4, 5, 6, 7, 8, 9, 10, 11, 12 or 13, the number of second data tones is 168; and/or
in a case where sizes of RUs in at least one of a virtual RU, a virtual MRU, a logical RU or a logical MRU allocated to a single STA are 484 tones and 242 tones respectively, and the MCS index is 15, the number of second data tones is 84.

20. A communication device, comprising: a processor and a memory, wherein the memory is configured to store a computer program, and the processor is configured to invoke and execute the computer program stored in the memory, to cause the communication device to perform:
receiving an orthogonal frequency division multiple access (OFDMA) extremely high throughput (EHT) physical layer protocol data unit (PPDU);
deinterleaving an interleaved resource unit (RU) according to first information carried in the OFDMA EHT PPDU, wherein the first information comprises at least one of a bandwidth, an interleaving granularity or RU allocation information.
